(19) United States
(12) Patent Application Publication
(10) Pub. No.: US 2024/0412065 A1
(43) Pub. Date: Dec. 12, 2024

(54) System, Method, and Computer Program Product for Denoising Sequential Machine Learning Models

(71) Applicant: Visa International Service Association, San Francisco, CA (US)

(72) Inventors: Huiyuan Chen, San Jose, CA (US); Yu-San Lin, San Francisco, CA (US); Menghai Pan, San Jose, CA (US); Lan Wang, Sunnyvale, CA (US); Michael Yeh, Newark, CA (US); Fei Wang, Fremont, CA (US); Hao Yang, San Jose, CA (US)

(21) Appl. No.: 18/702,382

(22) PCT Filed: Sep. 30, 2022
(86) PCT No.: PCT/US22/45337

§ 371 Date: Apr. 18, 2024

Related U.S. Application Data
(60) Provisional application No. 63/270,293, filed on Oct. 21, 2021.

(51) Int. Cl. G06N 3/08

(52) U.S. Cl. CPC G06N 3/08

(57) ABSTRACT

Described are a system, method, and computer program product for denoising sequential machine learning models. The method includes receiving data associated with a plurality of sequences and training a sequential machine learning model based on the data associated with the plurality of sequences to produce a trained sequential machine learning model. Training the sequential machine learning model includes denoising a plurality of sequential dependencies between items in the plurality of sequences using at least one trainable binary mask. The method also includes generating an output of the trained sequential machine learning model based on the denoised sequential dependencies. The method further includes generating a prediction of an item associated with a sequence of items based on the output of the trained sequential machine learning model.

### CROSS REFERENCE TO RELATED APPLICATIONS

This application is the United States national phase of International Application No. PCT/US2022/045337 filed Sep. 30, 2022, which claims the benefit of U.S. Provisional Patent Application No. 63/270,293, filed on Oct. 21, 2021, the disclosures of which are hereby incorporated by reference in their entireties.

### BACKGROUND

### 1. Technical Field

This disclosure relates generally to network behavior analysis and, in non-limiting embodiments or aspects, to systems, methods, and computer program products for denoising sequential machine learning models.

### 2. Technical Considerations

A neural network may refer to a computing system inspired by biological neural networks that is based on a collection of connected units (e.g., nodes, artificial neurons, etc.) which loosely model neurons in a biological brain. Neural networks may be used to solve artificial intelligence (AI) problems. A form of neural network may include a transformer, and a transformer may refer to a deep learning model that employs a mechanism of self-attention, where the significance of each part of input data is weighted differentially. In some instances, a transformer may be useful for modeling sequential data.

However, real-world sequences data may be incomplete and/or noisy, which may lead to sub-optimal performance by a transformer if the transformer is not regularized properly. In some instances, computer resources may be wasted by analyzing longer sequences of noisy data, which may take more time, processing capacity, and/or storage space. Further, computer resources may also be wasted by systems acting on next items in a sequence of data that are inaccurately generated from noisy sequences of data.

### SUMMARY

Accordingly, provided are improved systems, methods, and computer program products for denoising sequential machine learning models.

According to non-limiting embodiments or aspects, provided is a computer-implemented method for denoising sequential machine learning models. The method includes receiving, with at least one processor, data associated with a plurality of sequences, wherein each sequence of the plurality of sequences includes a plurality of items. The method also includes training, with at least one processor, a sequential machine learning model based on the data associated with the plurality of sequences to produce a trained sequential machine learning model. Training the sequential machine learning model includes inputting the data associated with the plurality of sequences to at least one self-attention layer of the sequential machine learning model. Training the sequential machine learning model also includes determining a plurality of sequential dependencies between items in the plurality of sequences using the at least one self-attention layer. Training the sequential machine learning model further includes denoising the plurality of sequential dependencies to produce denoised sequential dependencies. Denoising the plurality of sequential dependencies includes applying at least one trainable binary mask to each self-attention layer of the at least one self-attention layer. Denoising the plurality of sequential dependencies also includes training the at least one trainable binary mask to produce at least one trained binary mask. Denoising the plurality of sequential dependencies further includes excluding one or more sequential dependencies in the plurality of sequential dependencies to produce the denoised sequential dependencies based on the at least one trained binary mask. The method further includes generating, with at least one processor, an output of the trained sequential machine learning model based on the denoised sequential dependencies. Denoising the plurality of sequential dependencies further includes generating, with at least one processor, a prediction of an item associated with a sequence of items based on the output of the trained sequential machine learning model.

In some non-limiting embodiments or aspects, training the sequential machine learning model may include providing the plurality of sequential dependencies to at least one feed forward layer of the sequential machine learning model. Training the sequential machine learning model may also include generating, using the at least one feed forward layer, a plurality of weights associated with the plurality of sequential dependencies based on the plurality of sequential dependencies. Generating the prediction of the item associated with the sequence of items may include generating the prediction of the item associated with the sequence of items based on the weights associated with the plurality of sequential dependencies.

In some non-limiting embodiments or aspects, the method may include receiving, with at least one processor, the sequence of items. The method may also include inputting, with at least one processor, the sequence of items to the trained sequential machine learning model. Generating the prediction of the item associated with the sequence of items based on the output of the trained sequential machine learning model may include generating the prediction of the item associated with the sequence of items using at least one prediction layer of the trained sequential machine learning model.

In some non-limiting embodiments or aspects, the method may include generating, with at least one processor, a targeted advertisement based on the prediction of the item associated with the sequence of items. The method may also include transmitting, with at least one processor, the targeted advertisement to a computing device of a user.

In some non-limiting embodiments or aspects, the method may include receiving, with at least one processor, a transaction authorization request associated with a transaction. The method may also include determining, with at least one processor, a likelihood of fraud for the transaction authorization request based at least partly on a comparison of a transaction type of the transaction to a transaction type associated with the prediction of the item associated with the sequence of items. The method may further include determining, with at least one processor, that the likelihood of fraud satisfies a threshold. The method may further include performing, with at least one processor, a fraud mitigation action in response to determining that the likelihood of fraud satisfies the threshold.

In some non-limiting embodiments or aspects, the sequence of items may include a sequence of words. Receiving the sequence of items may include receiving the sequence of words from a computing device of a user. Generating the prediction of the item associated with the sequence of items may include generating a prediction of a word associated with the sequence of words. The method may also include transmitting, with at least one processor, the word to the computing device of the user.

In some non-limiting embodiments or aspects, at least one self-attention block may include one or more self-attention layers of the at least one self-attention layer and the at least one feed forward layer. Training the sequential machine learning model may include stabilizing the sequential machine learning model against perturbations in the data. Stabilizing the sequential machine learning model may include regularizing the at least one self-attention block. Regularizing the at least one self-attention block may include regularizing the at least one self-attention block using a Jacobian regularization technique.

According to non-limiting embodiments or aspects, provided is a system for denoising sequential machine learning models. The system includes at least one processor. The at least one processor is programmed or configured to receive data associated with a plurality of sequences, wherein each sequence of the plurality of sequences includes a plurality of items. The server is also programmed or configured to train a sequential machine learning model based on the data associated with the plurality of sequences to produce a trained sequential machine learning model. When training the sequential machine learning model, the at least one processor is programmed or configured to input the data associated with the plurality of sequences to at least one self-attention layer of the sequential machine learning model. When training the sequential machine learning model, the at least one processor is programmed or configured to determine a plurality of sequential dependencies between items in the plurality of sequences using the at least one self-attention layer. When training the sequential machine learning model, the at least one processor is programmed or configured to denoise the plurality of sequential dependencies to produce denoised sequential dependencies. When denoising the plurality of sequential dependencies, the at least one processor is programmed or configured to apply at least one trainable binary mask to each self-attention layer of the at least one self-attention layer. When denoising the plurality of sequential dependencies, the at least one processor is programmed or configured to train the at least one trainable binary mask to produce at least one trained binary mask. When denoising the plurality of sequential dependencies, the at least one processor is programmed or configured to exclude one or more sequential dependencies in the plurality of sequential dependencies to produce the denoised sequential dependencies based on the at least one trained binary mask. The at least one processor is further programmed or configured to generate an output of the trained sequential machine learning model based on the denoised sequential dependencies. The at least one processor is programmed or configured to generate a prediction of an item associated with a sequence of items based on the output of the trained sequential machine learning model.

In some non-limiting embodiments or aspects, when training the sequential machine learning model, the at least one processor may be programmed or configured to provide the plurality of sequential dependencies to at least one feed forward layer of the sequential machine learning model. When training the sequential machine learning model, the at least one processor may be programmed or configured to generate, using the at least one feed forward layer, a plurality of weights associated with the plurality of sequential dependencies based on the plurality of sequential dependencies. When generating the prediction of the item associated with the sequence of items, the at least one processor may be programmed or configured to generate the prediction of the item associated with the sequence of items based on the weights associated with the plurality of sequential dependencies.

In some non-limiting embodiments or aspects, the at least one processor may be further programmed or configured to receive the sequence of items. The at least one processor may be further programmed or configured to input the sequence of items to the trained sequential machine learning model. When generating the prediction of the item associated with the sequence of items, the at least one processor may be programmed or configured to generate the prediction of the item associated with the sequence of items using at least one prediction layer of the trained sequential machine learning model.

In some non-limiting embodiments or aspects, the at least one processor may be further programmed or configured to generate a targeted advertisement based on the prediction of the item associated with the sequence of items. The at least one processor may be further programmed or configured to transmit the targeted advertisement to a computing device of a user.

In some non-limiting embodiments or aspects, the at least one processor may be further programmed or configured to receive a transaction authorization request associated with a transaction. The at least one processor may be further programmed or configured to determine a likelihood of fraud for the transaction authorization request based at least partly on a comparison of a transaction type of the transaction to a transaction type associated with the prediction of the item associated with the sequence of items. The at least one processor may be further programmed or configured to determine that the likelihood of fraud satisfies a threshold. The at least one processor may be further programmed or configured to perform a fraud mitigation action in response to determining that the likelihood of fraud satisfies the threshold.

In some non-limiting embodiments or aspects, the sequence of items may include a sequence of words. When receiving the sequence of items, the at least one processor may be programmed or configured to receive the sequence of words from a computing device of a user. When generating the prediction of the item associated with the sequence of items, the at least one processor may be programmed or configured to generate a prediction of a word associated with the sequence of words. The at least one processor may be further programmed or configured to transmit the word to the computing device of the user.

According to non-limiting embodiments or aspects, provided is a computer program product for denoising sequential machine learning models. The computer program product may include at least one non-transitory computer-readable medium including one or more instructions that, when executed by at least one processor, cause the at least one processor to receive data associated with a plurality of sequences, wherein each sequence of the plurality of sequences includes a plurality of items. The one or more instructions also cause the at least one processor to train a sequential machine learning model based on the data associated with the plurality of sequences to produce a trained sequential machine learning model. The one or more instructions that cause the at least one processor to train the sequential machine learning model, cause the at least one processor to input the data associated with the plurality of sequences to at least one self-attention layer of the sequential machine learning model. The one or more instructions that cause the at least one processor to train the sequential machine learning model, cause the at least one processor to determine a plurality of sequential dependencies between items in the plurality of sequences using the at least one self-attention layer. The one or more instructions that cause the at least one processor to train the sequential machine learning model, cause the at least one processor to denoise the plurality of sequential dependencies to produce denoised sequential dependencies. The one or more instructions that cause the at least one processor to denoise the plurality of sequential dependencies, cause the at least one processor to apply at least one trainable binary mask to each self-attention layer of the at least one self-attention layer. The one or more instructions that cause the at least one processor to denoise the plurality of sequential dependencies, cause the at least one processor to train the at least one trainable binary mask to produce at least one trained binary mask. The one or more instructions that cause the at least one processor to denoise the plurality of sequential dependencies, cause the at least one processor to exclude one or more sequential dependencies in the plurality of sequential dependencies to produce the denoised sequential dependencies based on the at least one trained binary mask. The one or more instructions further cause the at least one processor to generate an output of the trained sequential machine learning model based on the denoised sequential dependencies. The one or more instructions further cause the at least one processor to generate a prediction of an item associated with a sequence of items based on the output of the trained sequential machine learning model.

In some non-limiting embodiments or aspects, the one or more instructions that cause the at least one processor to train the sequential machine learning model, may cause the at least one processor to provide the plurality of sequential dependencies to at least one feed forward layer of the sequential machine learning model. The one or more instructions that cause the at least one processor to train the sequential machine learning model, may cause the at least one processor to generate, using the at least one feed forward layer, a plurality of weights associated with the plurality of sequential dependencies based on the plurality of sequential dependencies. The one or more instructions that cause the at least one processor to generate the prediction of the item associated with the sequence of items, may cause the at least one processor to generate the prediction of the item associated with the sequence of items based on the weights associated with the plurality of sequential dependencies.

In some non-limiting embodiments or aspects, the one or more instructions may further cause the at least one processor to receive the sequence of items. The one or more instructions may further cause the at least one processor to input the sequence of items to the trained sequential machine learning model. The one or more instructions that cause the at least one processor to generate the prediction of the item associated with the sequence of items, may cause the at least one processor to generate the prediction of the item associated with the sequence of items using at least one prediction layer of the trained sequential machine learning model.

In some non-limiting embodiments or aspects, the one or more instructions may further cause the at least one processor to generate a targeted advertisement based on the prediction of the item associated with the sequence of items. The one or more instructions may further cause the at least one processor to transmit the targeted advertisement to a computing device of a user.

In some non-limiting embodiments or aspects, the one or more instructions may further cause the at least one processor to receive a transaction authorization request associated with a transaction. The one or more instructions may further cause the at least one processor to determine a likelihood of fraud for the transaction authorization request based at least partly on a comparison of a transaction type of the transaction to a transaction type associated with the prediction of the item associated with the sequence of items. The one or more instructions may further cause the at least one processor to determine that the likelihood of fraud satisfies a threshold. The one or more instructions may further cause the at least one processor to perform a fraud mitigation action in response to determining that the likelihood of fraud satisfies the threshold.

In some non-limiting embodiments or aspects, the sequence of items may include a sequence of words. The one or more instructions that cause the at least one processor to receive the sequence of items, may cause the at least one processor to receive the sequence of words from a computing device of a user. The one or more instructions that cause the at least one processor to generate the prediction of the item associated with the sequence of items, may cause the at least one processor to generate a prediction of a word associated with the sequence of words. The one or more instructions may further cause the at least one processor to transmit the word to the computing device of the user.

Further non-limiting embodiments or aspects will be set forth in the following numbered clauses:

Clause 1: A computer-implemented method comprising: receiving, with at least one processor, data associated with a plurality of sequences, wherein each sequence of the plurality of sequences comprises a plurality of items; training, with at least one processor, a sequential machine learning model based on the data associated with the plurality of sequences to produce a trained sequential machine learning model, wherein training the sequential machine learning model comprises: inputting the data associated with the plurality of sequences to at least one self-attention layer of the sequential machine learning model; determining a plurality of sequential dependencies between items in the plurality of sequences using the at least one self-attention layer; and denoising the plurality of sequential dependencies to produce denoised sequential dependencies, wherein denoising the plurality of sequential dependencies comprises: applying at least one trainable binary mask to each self-attention layer of the at least one self-attention layer; training the at least one trainable binary mask to produce at least one trained binary mask; and excluding one or more sequential dependencies in the plurality of sequential dependencies to produce the denoised sequential dependencies based on the at least one trained binary mask; generating, with at least one processor, an output of the trained sequential machine learning model based on the denoised sequential dependencies; and generating, with at least one processor, a prediction of an item associated with a sequence of items based on the output of the trained sequential machine learning model.

Clause 2: The computer-implemented method of clause 1, wherein training the sequential machine learning model comprises: providing the plurality of sequential dependencies to at least one feed forward layer of the sequential machine learning model; and generating, using the at least one feed forward layer, a plurality of weights associated with the plurality of sequential dependencies based on the plurality of sequential dependencies; and wherein generating the prediction of the item associated with the sequence of items comprises: generating the prediction of the item associated with the sequence of items based on the weights associated with the plurality of sequential dependencies.

Clause 3: The computer-implemented method of clause 1 or clause 2, further comprising: receiving, with at least one processor, the sequence of items; and inputting, with at least one processor, the sequence of items to the trained sequential machine learning model; wherein generating the prediction of the item associated with the sequence of items based on the output of the trained sequential machine learning model comprises: generating the prediction of the item associated with the sequence of items using at least one prediction layer of the trained sequential machine learning model.

Clause 4: The computer-implemented method of any of clauses 1-3, the method further comprising: generating, with at least one processor, a targeted advertisement based on the prediction of the item associated with the sequence of items; and transmitting, with at least one processor, the targeted advertisement to a computing device of a user.

Clause 5: The computer-implemented method of any of clauses 1-4, further comprising: receiving, with at least one processor, a transaction authorization request associated with a transaction; determining, with at least one processor, a likelihood of fraud for the transaction authorization request based at least partly on a comparison of a transaction type of the transaction to a transaction type associated with the prediction of the item associated with the sequence of items; determining, with at least one processor, that the likelihood of fraud satisfies a threshold; and performing, with at least one processor, a fraud mitigation action in response to determining that the likelihood of fraud satisfies the threshold.

Clause 6: The computer-implemented method of any of clauses 1-5, wherein: the sequence of items comprises a sequence of words; wherein receiving the sequence of items comprises: receiving the sequence of words from a computing device of a user; and wherein generating the prediction of the item associated with the sequence of items comprises: generating a prediction of a word associated with the sequence of words; and the method further comprising: transmitting, with at least one processor, the word to the computing device of the user.

Clause 7: The computer-implemented method of any of clauses 1-6, wherein at least one self-attention block comprises one or more self-attention layers of the at least one self-attention layer and the at least one feed forward layer, and wherein training the sequential machine learning model comprises: stabilizing the sequential machine learning model against perturbations in the data, wherein stabilizing the sequential machine learning model comprises: regularizing the at least one self-attention block.

Clause 8: The computer-implemented method of any of clauses 1-7, wherein regularizing the at least one self-attention block comprises: regularizing the at least one self-attention block using a Jacobian regularization technique.

Clause 9: A system comprising at least one processor programmed or configured to: receive data associated with a plurality of sequences, wherein each sequence of the plurality of sequences comprises a plurality of items; train a sequential machine learning model based on the data associated with the plurality of sequences to produce a trained sequential machine learning model, wherein, when training the sequential machine learning model, the at least one processor is programmed or configured to: input the data associated with the plurality of sequences to at least one self-attention layer of the sequential machine learning model; determine a plurality of sequential dependencies between items in the plurality of sequences using the at least one self-attention layer; and denoise the plurality of sequential dependencies to produce denoised sequential dependencies, wherein, when denoising the plurality of sequential dependencies, the at least one processor is programmed or configured to: apply at least one trainable binary mask to each self-attention layer of the at least one self-attention layer; train the at least one trainable binary mask to produce at least one trained binary mask; and exclude one or more sequential dependencies in the plurality of sequential dependencies to produce the denoised sequential dependencies based on the at least one trained binary mask; generate an output of the trained sequential machine learning model based on the denoised sequential dependencies; and generate a prediction of an item associated with a sequence of items based on the output of the trained sequential machine learning model.

Clause 10: The system of clause 9, wherein, when training the sequential machine learning model, the at least one processor is programmed or configured to: provide the plurality of sequential dependencies to at least one feed forward layer of the sequential machine learning model; and generate, using the at least one feed forward layer, a plurality of weights associated with the plurality of sequential dependencies based on the plurality of sequential dependencies; and wherein, when generating the prediction of the item associated with the sequence of items, the at least one processor is programmed or configured to: generate the prediction of the item associated with the sequence of items based on the weights associated with the plurality of sequential dependencies.

Clause 11: The system of clause 9 or clause 10, wherein the at least one processor is further programmed or configured to: receive the sequence of items; and input the sequence of items to the trained sequential machine learning model; wherein, when generating the prediction of the item associated with the sequence of items, the at least one processor is programmed or configured to: generate the prediction of the item associated with the sequence of items using at least one prediction layer of the trained sequential machine learning model.

Clause 12: The system of any of clauses 9-11, wherein the at least one processor is further programmed or configured to: generate a targeted advertisement based on the prediction of the item associated with the sequence of items; and transmit the targeted advertisement to a computing device of a user.

Clause 13: The system of any of clauses 9-12, wherein the at least one processor is further programmed or configured to: receive a transaction authorization request associated with a transaction; determine a likelihood of fraud for the transaction authorization request based at least partly on a comparison of a transaction type of the transaction to a transaction type associated with the prediction of the item associated with the sequence of items; determine that the likelihood of fraud satisfies a threshold; and perform a fraud mitigation action in response to determining that the likelihood of fraud satisfies the threshold.

Clause 14: The system of any of clauses 9-13, wherein: the sequence of items comprises a sequence of words; wherein, when receiving the sequence of items, the at least one processor is programmed or configured to: receive the sequence of words from a computing device of a user; wherein, when generating the prediction of the item associated with the sequence of items, the at least one processor is programmed or configured to: generate a prediction of a word associated with the sequence of words; and wherein the at least one processor is further programmed or configured to: transmit the word to the computing device of the user.

Clause 15: A computer program product comprising at least one non-transitory computer-readable medium comprising one or more instructions that, when executed by at least one processor, cause the at least one processor to: receive data associated with a plurality of sequences, wherein each sequence of the plurality of sequences comprises a plurality of items; train a sequential machine learning model based on the data associated with the plurality of sequences to produce a trained sequential machine learning model, wherein, the one or more instructions that cause the at least one processor to train the sequential machine learning model, cause the at least one processor to: input the data associated with the plurality of sequences to at least one self-attention layer of the sequential machine learning model; determine a plurality of sequential dependencies between items in the plurality of sequences using the at least one self-attention layer; and denoise the plurality of sequential dependencies to produce denoised sequential dependencies, wherein, the one or more instructions that cause the at least one processor to denoise the plurality of sequential dependencies, cause the at least one processor to: apply at least one trainable binary mask to each self-attention layer of the at least one self-attention layer; train the at least one trainable binary mask to produce at least one trained binary mask; and exclude one or more sequential dependencies in the plurality of sequential dependencies to produce the denoised sequential dependencies based on the at least one trained binary mask; generate an output of the trained sequential machine learning model based on the denoised sequential dependencies; and generate a prediction of an item associated with a sequence of items based on the output of the trained sequential machine learning model.

Clause 16: The computer program product of clause 15, wherein, the one or more instructions that cause the at least one processor to train the sequential machine learning model, cause the at least one processor to: provide the plurality of sequential dependencies to at least one feed forward layer of the sequential machine learning model; and generate, using the at least one feed forward layer, a plurality of weights associated with the plurality of sequential dependencies based on the plurality of sequential dependencies; and wherein, the one or more instructions that cause the at least one processor to generate the prediction of the item associated with the sequence of items, cause the at least one processor to: generate the prediction of the item associated with the sequence of items based on the weights associated with the plurality of sequential dependencies.

Clause 17: The computer program product of clause 15 or clause 16, wherein the one or more instructions further cause the at least one processor to: receive the sequence of items; and input the sequence of items to the trained sequential machine learning model; wherein, the one or more instructions that cause the at least one processor to generate the prediction of the item associated with the sequence of items, cause the at least one processer to: generate the prediction of the item associated with the sequence of items using at least one prediction layer of the trained sequential machine learning model.

Clause 18: The computer program product of any of clauses 15-17, wherein the one or more instructions further cause the at least one processor to: generate a targeted advertisement based on the prediction of the item associated with the sequence of items; and transmit the targeted advertisement to a computing device of a user.

Clause 19: The computer program product of any of clauses 15-18, wherein the one or more instructions further cause the at least one processor to: receive a transaction authorization request associated with a transaction; determine a likelihood of fraud for the transaction authorization request based at least partly on a comparison of a transaction type of the transaction to a transaction type associated with the prediction of the item associated with the sequence of items; determine that the likelihood of fraud satisfies a threshold; and perform a fraud mitigation action in response to determining that the likelihood of fraud satisfies the threshold.

Clause 20: The computer program product of any of clauses 15-19, wherein: the sequence of items comprises a sequence of words; wherein, the one or more instructions that cause the at least one processor to receive the sequence of items, cause the at least one processor to: receive the sequence of words from a computing device of a user; wherein, the one or more instructions that cause the at least one processor to generate the prediction of the item associated with the sequence of items, cause the at least one processor to: generate a prediction of a word associated with the sequence of words; and wherein the one or more instructions further cause the at least one processor to: transmit the word to the computing device of the user.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments or aspects that are illustrated in the accompanying schematic figures, in which:

FIG. 1 is a diagram of a non-limiting embodiment or aspect of an environment in which systems, devices, products, apparatus, and/or methods, described herein, may be implemented, according to the principles of the present disclosure;

FIG. 2 is a diagram of one or more components, devices, and/or systems, according to some non-limiting embodiments or aspects;

FIG. 3 is a flowchart of a method for denoising sequential machine learning models, according to some non-limiting embodiments or aspects;

FIG. 4 is a flowchart of a method for denoising sequential machine learning models, according to some non-limiting embodiments or aspects;

FIG. 5 is a flowchart of a method for denoising sequential machine learning models, according to some non-limiting embodiments or aspects;

FIG. 6 is a flowchart of a method for using a denoised sequential machine learning model, according to some non-limiting embodiments or aspects;

FIG. 7 is a flowchart of a method for using a denoised sequential machine learning model, according to some non-limiting embodiments or aspects; and

FIG. 8 is a diagram of a sequential machine learning model, according to some non-limiting embodiments or aspects.

### DETAILED DESCRIPTION

For purposes of the description hereinafter, the terms “upper”, “lower”, “right”, “left”, “vertical”, “horizontal”, “top”, “bottom”, “lateral”, “longitudinal,” and derivatives thereof shall relate to non-limiting embodiments or aspects as they are oriented in the drawing figures. However, it is to be understood that non-limiting embodiments or aspects may assume various alternative variations and step sequences, except where expressly specified to the contrary. It is also to be understood that the specific devices and processes illustrated in the attached drawings, and described in the following specification, are simply exemplary embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. The phase “based on” may also mean “in response to” where appropriate. For example, the phrases “based on” and “in response to” may, in some non-limiting embodiments or aspects, refer to a condition for automatically triggering an action (e.g., a specific operation of an electronic device, such as a computing device, a processor, and/or the like).

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, a “sequence” may refer to any ordered arrangement of data having at least one same type of parameter by which a sequential model may be executed to predict a next item in the sequence. As used herein, an “item” may refer to a representation of a sequentially observable event or object. Items may represent real world items (e.g., purchasable goods), data objects (e.g., user interface components, identifiers of songs, books, games, movies, users, etc.), text (e.g., strings, words, etc.), numbers (e.g., phone numbers, account numbers, etc.), combinations of text and numbers (e.g., unique identifiers for real world or data objects), transactions (e.g., payment transactions in an electronic payment processing network), and/or the like. As used herein, a “sequential dependency” may be a relation (e.g., a correlation, positive association, etc.) between two or more items in a sequence. As used herein, a “prediction” of an item associated with a sequence of items may refer to data representing an item having the same type of parameter of the sequence of data, which may represent a value of the parameter in a time period (e.g., time step) subsequent to (e.g., immediately, or not immediately, after) the time period (e.g., time step) of an input sequence of items. For example, a prediction of an item associated with a sequence of items may be, but is not limited to, a transaction, transaction amount, transaction time, transaction type, transaction description (e.g., of a good or service to be purchased), transaction merchant, a word, and/or the like.

The systems, methods, and computer program products described herein provide numerous technical advantages in systems for denoising sequential machine learning models. First, the described processes for denoising sequential machine learning models greatly reduce the computational resources required to input the sequence, process the sequence, and output a prediction based on the sequence. This is at least partly due to the described processes reducing a size of the original noisy sequential dependencies to a smaller set of more relevant sequential dependencies. The magnitude of sequence size reduction may be as great as a reduction from 10,000 elements to 100 elements, or better. This sequence size reduction greatly improves the computation efficiency (e.g., reduced processing capacity, decreased bandwidth for transmission, decreased memory for storage, etc.) related to analyzing the sequence of data. Moreover, because the sequential machine learning model has been denoised to improve the meaningfulness of the set of sequential dependencies therein, the performance of systems relying on the trained sequential machine learning model will be improved. More accurate predicted sequences will reduce computer resource waste attributed to rectifying or incorrectly predicting future sequences, and they may further reduce computer resource waste when applied to anomaly mitigation (e.g., fraud detection), in which case, predicting and preventing anomalous and system-taxing behavior will improve the efficiency of the overall system.

Transformers may be powerful tools for sequential modeling, due to the application of self-attention among sequences. However, real-world sequences may be incomplete and noisy (e.g., particularly for implicit feedback sequences), which may lead to suboptimal transformer performance. The present disclosure provides for pruning a sequence to enhance the performance of transformers, through the exploitation of sequence structure. To achieve sparsity, non-limiting embodiments or aspects of the present disclosure apply a trainable binary mask to each layer of a self-attention sequential machine learning model to prune noisy sequential dependencies (e.g., interrelated, correlated, and/or positively associated sequenced items, also referred to as subsequences, herein), resulting in a clean and sparsified graph. The parameters of the binary mask and original transformer may be jointly learned by solving a stochastic binary optimization problem. Non-limiting embodiments or aspects of the present disclosure also improve back-propagation of the gradients of binary variables through the use of an unbiased gradient estimator (described further herein in relation to regularization). In this manner, the present disclosure provides for training a self-attention-based sequential machine learning model that allows the capture of long-term semantics (e.g., like a recurrent neural network (RNN)), but, using an attention mechanism, makes predictions based on relatively few actions (e.g., like a Markov chain (MC)). For example, at each time step, described methods may seek to identify which items are relevant from a user's action history and use them to predict the next item. Extensive empirical studies show that the described methods outperform MC-, RNN-, and convolutional neural network (CNN)-based approaches. Experimental results also demonstrate that the disclosed methods achieve better performance compared to known transformers, which are typically not Lipschitz continuous and are vulnerable to small perturbations. For clarity, a function is Lipschitz continuous if changing the function's input by a certain amount will not significantly change the function's output.

There are numerous applications for the systems, methods, and computer program products of the present disclosure. For example, the described solutions may be used in personalized recommender systems (e.g., in an online-deployed service to filter content based on user interest). By way of further example, described solutions may be used for collaborative filtering implementations, which may consider a user's historical interactions and assume that users who share similar preferences in the past tend to make similar decisions in the future. In this manner, the use of the described methods in sequential recommender systems may combine personalized models of user behavior (e.g., based on historical activities) with a notion of context based on a plurality of users' recent actions. By way of further example, described solutions may be employed in fraud detection systems (e.g., to help identify fraudulent behavior at least partly due to predicted items in a sequence) or natural language processing systems (e.g., by predicting a following word in a sequence, given an input sequence of words).

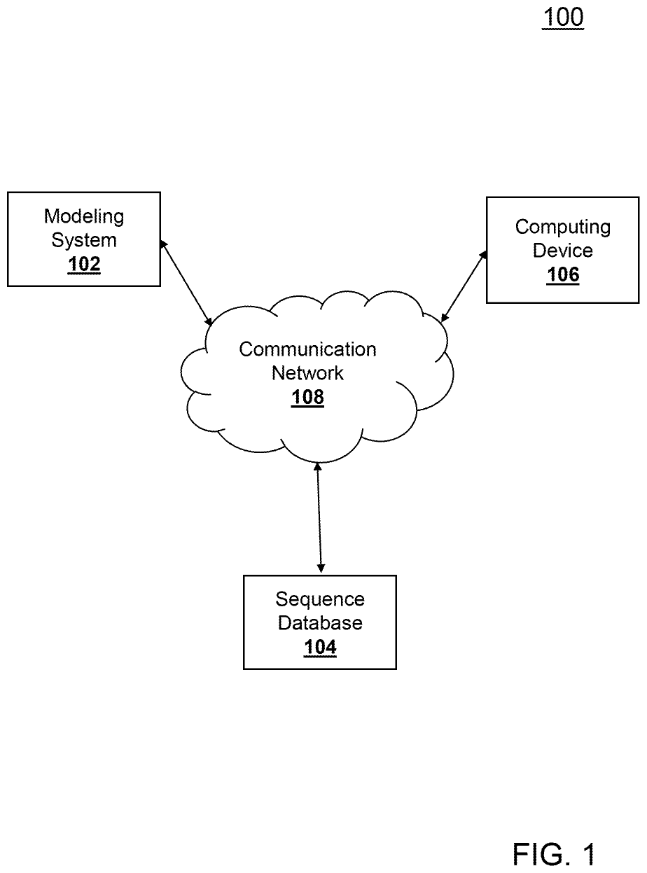

Referring now to FIG. 1, FIG. 1 is a diagram of an example environment 100 in which devices, systems, and/or methods, described herein, may be implemented. As shown in FIG. 1, environment 100 may include modeling system 102, sequence database 104, computing device 106, and communication network 108. Modeling system 102, sequence database 104, and computing device 106 may interconnect (e.g., establish a connection to communicate) via wired connections, wireless connections, or a combination of wired and wireless connections. In some non-limiting embodiments or aspects, environment 100 may further include a natural language processing system, an advertising system, a fraud detection system, a transaction processing system, a merchant system, an acquirer system, an issuer system, and/or a payment device.

Modeling system 102 may include one or more computing devices configured to communicate with sequence database 104 and/or computing device 106 at least partly over communication network 108. Modeling system 102 may be configured to receive data to train one or more sequential machine learning models, train one or more sequential machine learning models, and use one or more trained sequential machine learning models to generate an output. Modeling system 102 may include or be in communication with sequence database 104. Modeling system 102 may be associated with, or included in a same system as, a natural language processing system, a fraud detection system, an advertising system, and/or a transaction processing system.

Sequence database 104 may include one or more computing devices configured to communicate with modeling system 102 and/or computing device 106 at least partly over communication network 108. Sequence database 104 may be configured to store data associated with sequences (e.g., data comprising one or more lists, arrays, vectors, sequential arrangements of data objects, etc.) in one or more non-transitory computer readable storage media. Sequence database 104 may communicate with and/or be included in modeling system 102.

Computing device 106 may include one or more processors that are configured to communicate with modeling system 102 and/or sequence database 104 at least partly over communication network 108. Computing device 106 may be associated with a user and may include at least one user interface for transmitting data to and receiving data from modeling system 102 and/or sequence database 104. For example, computing device 106 may show, on a display of computing device 106, one or more outputs of trained sequential machine learning models executed by modeling system 102. By way of further example, one or more inputs for trained sequential machine learning models may be determined or received by modeling system 102 via a user interface of computing device 106. Computing device 106 may further store payment device data or act as a payment device (e.g., issued by an issuer associated with an issuer system) for completing transactions with merchants associated with merchant systems. In some non-limiting embodiments or aspects, a user may have a payment device that is not associated with computing device 106 to complete transactions in an electronic payment processing network that includes, at least partly, communication network 108 and one or more devices of environment 100. A payment device may or may not be capable of independently communicating over communication network 108. Computing device 106 may have an input component for a user to enter text that may be used as an input for trained sequential machine learning models (e.g., for natural language processing). In some non-limiting embodiments or aspects, computing device 106 may be a mobile device.

Communication network 108 may include one or more wired and/or wireless networks over which the systems and devices of environment 100 may communicate. For example, communication network 108 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

In some non-limiting embodiments or aspects, modeling system 102 may receive data associated with a plurality of sequences, wherein each sequence of the plurality of sequences includes a plurality of items. Modeling system 102 may train a sequential machine learning model based on the data associated with the plurality of sequences to produce a trained sequential machine learning model. Modeling system 102 may train the sequential machine learning model by (i) inputting the data associated with the plurality of sequences to at least one self-attention layer of the sequential machine learning model, (ii) determining a plurality of sequential dependencies between two or more items in a sequence using the at least one self-attention layer, and (iii) denoising the plurality of sequential dependencies to produce denoised sequential dependencies. Modeling system 102 may denoise the plurality of sequential dependencies by (i) applying at least one trainable binary mask to each self-attention layer of the at least one self-attention layer, (ii) training the at least one trainable binary mask to produce at least one trained binary mask, and (iii) excluding one or more sequential dependencies in the plurality of sequential dependencies to produce the denoised sequential dependencies based on the at least one trained binary mask. Modeling system 102 may generate an output of the trained sequential machine learning model based on the denoised sequential dependencies and generate a prediction of an item associated with a sequence of items based on the output.

In some non-limiting embodiments or aspects, modeling system 102 may train the sequential machine learning model by providing the plurality of sequential dependencies to at least one feed forward layer of the sequential machine learning model and generate a plurality of weights associated with the plurality of sequential dependencies. In doing so, modeling system's 102 prediction of the item associated with the sequence of items may be based on the weights associated with the plurality of sequential dependencies (e.g., favoring higher weighted dependencies to be predicted and disfavoring lesser weighted dependencies to be predicted). Modeling system 102 may further train the sequential machine learning model by stabilizing the sequential machine learning model against perturbations in the data, which may include regularizing at least one self-attention block (e.g., one or more self-attention layers and one or more feed forward layers) of the sequential machine learning model, such as by using a Jacobian regularization technique.

In some non-limiting embodiments or aspects, modeling system 102 may receive the sequence of items (e.g., from computing device 106, from a transaction processing system, etc.) and input the received sequence of items to the trained sequential machine learning model. In some non-limiting embodiments or aspects, modeling system 102 may generate a targeted advertisement based on the prediction and transmit the targeted advertisement to computing device 106 of the user. In such non-limiting embodiments or aspects, modeling system 102 may be associated with, or included in a same system as, an advertising system. In some non-limiting embodiments or aspects, modeling system 102 may receive a transaction authorization request, determine a likelihood of fraud for the transaction authorization request based on the prediction, determine that the likelihood of fraud satisfies a threshold, and perform a fraud mitigation action in response to determining that the likelihood of fraud satisfies the threshold. In such non-limiting embodiments or aspects, modeling system 102 may be associated with, or included in a same system as, a fraud detection system and/or a transaction processing system. In some non-limiting embodiments or aspects, the sequence of items may include a sequence of words, in which case modeling system 102 may receive the sequence of words from computing device 106 (e.g., of a user), generate the prediction of a word by inputting the sequence of words to the trained sequential machine learning model, and transmit the word back to computing device 106. In some non-limiting embodiments or aspects, modeling system 102 may be associated with, or included in a same system as, a natural language processing system.

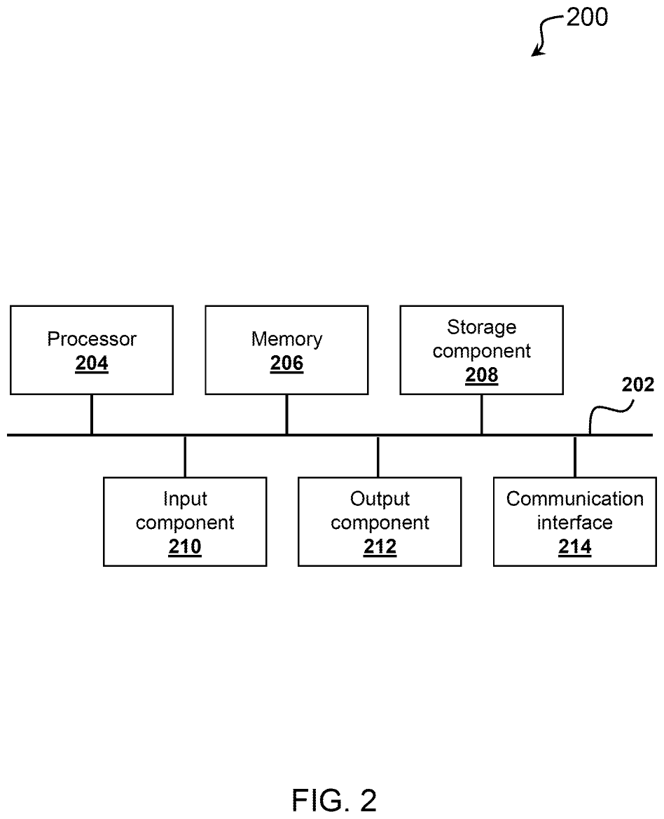

Referring now to FIG. 2, FIG. 2 is a diagram of example components of a device 200 according to some non-limiting embodiments or aspects. Device 200 may correspond to one or more devices of modeling system 102, sequence database 104, computing device 106, and/or communication network 108 as shown in FIG. 1. In some non-limiting embodiments or aspects, such systems or devices may include at least one device 200 and/or at least one component of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.) and/or another type of computer-readable medium.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

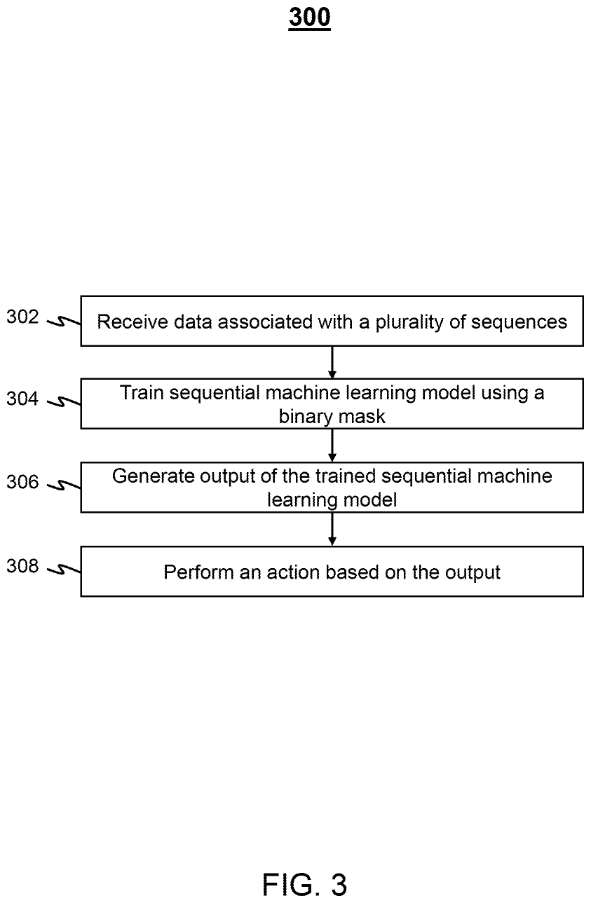

Referring now to FIG. 3, FIG. 3 is a flowchart of a non-limiting embodiment or aspect of a process 300 for denoising sequential machine learning models, according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by modeling system 102. In some non-limiting embodiments or aspects, one or more of the steps of process 300 may be performed (e.g., completely, partially, and/or the like) by another system, another device, another group of systems, or another group of devices, separate from or including modeling system 102.

As shown in FIG. 3, at step 302, process 300 may include receiving data associated with a plurality of sequences. For example, modeling system 102 may receive data associated with a plurality of sequences, wherein each sequence of the plurality of sequences includes a plurality of items. Each sequence of the plurality of sequences may include two or more items. Data associated with each sequence of the plurality of sequences may include a plurality of identifiers, text data, numerical data, and/or the like. In some non-limiting embodiments or aspects, the plurality of sequences may be associated with a plurality of sequences of transactions. In some non-limiting embodiments or aspects, the plurality of sequences may be associated with a plurality of sequences of words.

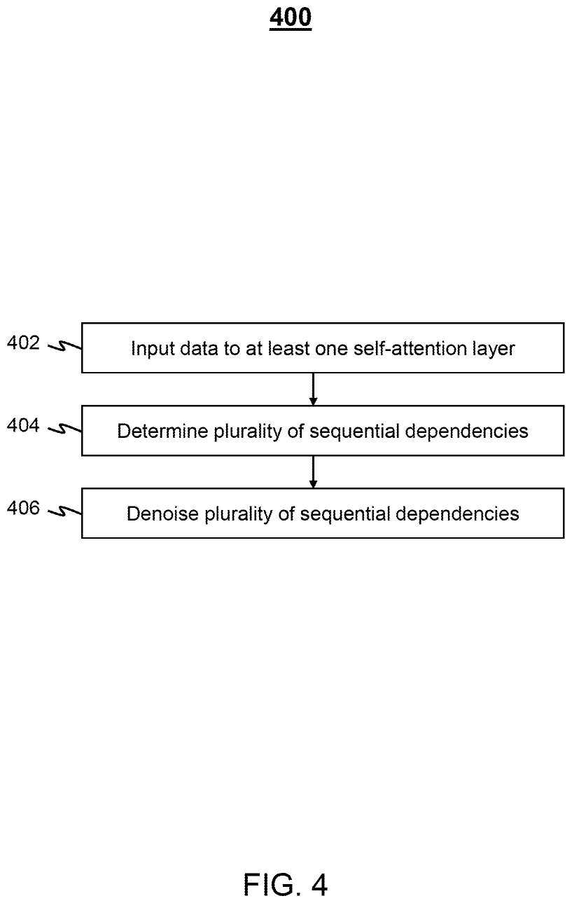

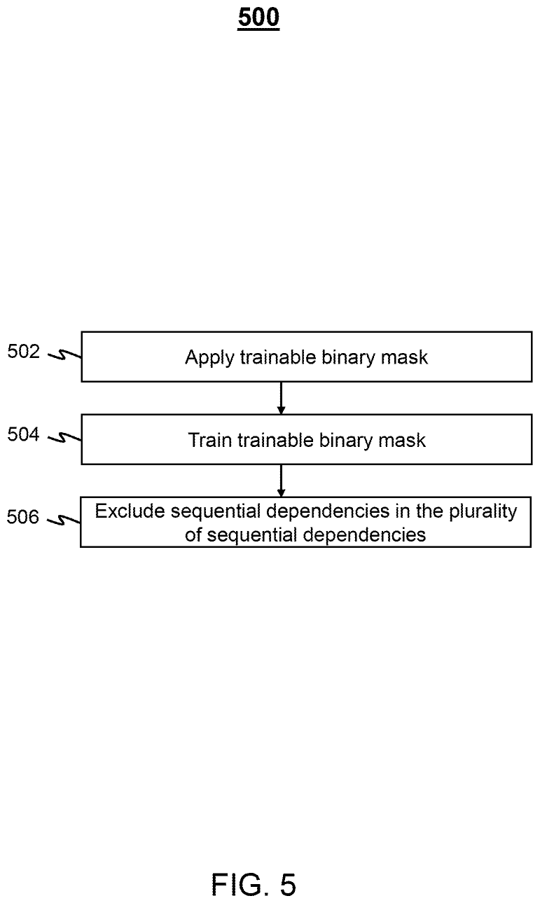

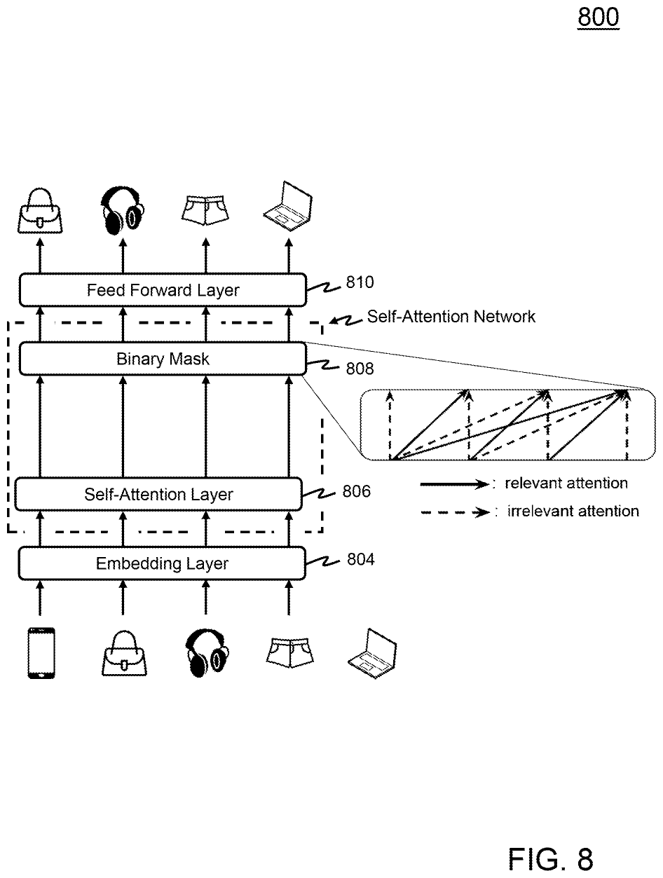

As shown in FIG. 3, at step 304, process 300 may include training a sequential machine learning model using a binary mask. For example, modeling system 102 may train a sequential machine learning model based on the data associated with the plurality of sequences (e.g., that are received at step 302) and using a binary mask. The sequential machine learning model may be a sequential machine learning model of the type shown in FIG. 8 (e.g., a transformer), wherein the sequential machine learning model includes one or more embedding layers 804, one or more self-attention layers 806, one or more binary masks 808, one or more feed forward layers 810, and one or more prediction layers (e.g., including one or more feed forward layers 810 that terminate and produce a final output). Modeling system 102 may produce a trained sequential machine learning model by training the sequential machine learning model. Training the sequential machine learning model may include process 400 shown in FIG. 4 and process 500 shown in FIG. 5. A trained sequential machine learning model may be used to produce output based on learned sequential dependencies, and the sequential dependencies may be denoised by using a binary mask.

As shown in FIG. 3, at step 306, process 300 may include generating an output of the trained sequential machine learning model. For example, modeling system 102 may generate an output of the trained sequential machine learning model based on sequential dependencies determined during the training of the sequential machine learning model (see process 400 of FIG. 4). By way of further example, the output of the trained sequential machine learning model may be based on denoised sequential dependencies generated during the training of the sequential machine learning model (see process 500 of FIG. 5).

In some non-limiting embodiments or aspects, generating the output, at step 306, may include receiving a sequence of items and providing the sequence of items as input to the trained sequential machine learning model. For example, modeling system 102 may receive a sequence of items and provide the sequence of items as input to the trained sequential machine learning model. The sequence of items may be input to the trained sequential machine learning model by first being processed into a sequence of representations of items using at least one embedding layer of the trained sequential machine learning model. Modeling system 102 may generate an output based on the sequence of items that are received by modeling system 102 and input to the trained sequential machine learning model. In some non-limiting embodiments or aspects, the sequence of items may be associated with a user, such that the prediction may be specific to the user. For example, the received sequence of items may be associated with a plurality of transactions completed by a user, such that the output is associated with a prediction of a following transaction likely to be made by the user (e.g., immediately next after the sequence of transactions, occurring in a sequence that is subsequent to the input sequence of items, etc.), either voluntarily or by inducement via targeted advertisement. By way of further example, the sequence of items may be a sequence of words, such that the prediction is to predict a word following the input sequence of words (e.g., for natural language processing, in predictive text sequential machine learning models, etc.). The sequence of items may be received from sequence database 104 associated with modeling system 102, may be received by modeling system 102 or a system that includes modeling system 102, may be determined from transactions processed using a transaction processing system, may be received by computing device 106 associated with the user, and/or the like.

As shown in FIG. 3, at step 308, process 300 may include performing an action based on the output. For example, modeling system 102 may perform an action based on the output. In some non-limiting embodiments or aspects, performing an action may include generating a prediction of an item associated with a sequence of items based on the output. For example, modeling system 102 may generate a prediction of an item associated with a sequence of items based on the output of the trained sequential machine learning model. A prediction may be an indication that an item is likely to be observed (e.g., existing/occurring with a probability exceeding a predetermined threshold) subsequent to the input sequence of items. An item associated with the sequence of items may be an item that is of the same type (e.g., from a same category, such as real world objects, data objects, words, etc.) as the items of the input sequence of items. A subsequent observation of the predicted item may be interpreted as the item occurring/existing subsequent to the input sequence of items (e.g., next, which is immediately after the input sequence of items, or in a sequence of items that follows the input sequence of items). The prediction may be based on the output by being the output, by being a representation of the output (e.g., reformatted to correspond to the input), or by being related to the output (e.g., selected from a set of items similar to an output item). For example, the trained sequential machine learning model may output a word, which may be directly used as a prediction. By way of further example, the trained sequential machine learning model may output an identifier of a real world item, and the prediction may be a description of the real world item that is associated with the identifier. By way of further example, the trained sequential machine learning model may output a category of item (e.g., an adjective word, a video game to be purchased, etc.), and the prediction may be selected from a set of the category (e.g., a set of adjective words, a set of video games, etc.). By way of further example, the trained sequential machine learning model may output a parameter of an item (e.g., a transaction type, a merchant identifier, a transaction description, etc.), and the prediction may have the same parameter as the output.

In some non-limiting embodiments or aspects, performing an action based on the output, at step 308, may include generating a targeted advertisement. For example, modeling system 102 (e.g., being associated with, or included in a same system as, an advertising system) may generate a targeted advertisement based on the prediction of the item associated with the sequence of items. In some non-limiting embodiments or aspects, the prediction may be generated by inputting a sequence of transactions (as the sequence of items) completed by a user (e.g., with a payment device) to the trained sequential machine learning model. The output from the trained sequential machine learning model may be, but is not limited to, a transaction or type of transaction (e.g., category of good/service, merchant category, etc.). The output may indicate that the user is likely to engage in the transaction or type of transaction in the future (e.g., voluntarily or through inducement). Accordingly, in some non-limiting embodiments or aspects, the targeted advertisement may be configured to encourage the user to engage in the transaction, or type of transaction, of the output. By way of further example, the prediction based on the output may indicate that it is likely the user will purchase (or would purchase, if presented the opportunity) a luxury watch in the future, based on the transactions already completed by the user (e.g., in the input sequence of transactions). In such an example, the targeted advertisement may include information about a luxury watch, or merchant that sells luxury watches, in order to encourage the user to engage in the transaction of the prediction. Modeling system 102 may then transmit the generated targeted advertisement to computing device 106 of a user. In some non-limiting embodiments or aspects, computing device 106 may have been used by the user to complete previous transactions from the input sequence of transactions. In some non-limiting embodiments or aspects, computing device 106 of the user may provide payment device data, or be the payment device of the user. The user may be prompted to complete the transaction of the targeted advertisement, via the targeted advertisement, on the user's computing device 106.

Referring now to FIG. 4, FIG. 4 is a flowchart of a non-limiting embodiment or aspect of a process 400 for training a sequential machine learning model. The steps shown in FIG. 4 are for example purposes only. It will be appreciated that additional, fewer, different, and/or a different order of steps may be used in non-limiting embodiments or aspects. In some non-limiting embodiments or aspects, one or more of the steps of process 400 may be performed (e.g., completely, partially, and/or the like) by modeling system 102. In some non-limiting embodiments or aspects, one or more of the steps of process 400 may be performed (e.g., completely, partially, and/or the like) by another system, another device, another group of systems, or another group of devices, separate from or including modeling system 102.

As shown in FIG. 4, at step 402, process 400 may include inputting the data associated with the plurality of sequences to at least one self-attention layer. For example, modeling system 102 may input the data (e.g., received at step 302 of process 300; see FIG. 3) associated with the plurality of sequences to at least one self-attention layer of the sequential machine learning model. In some non-limiting embodiments or aspects, a self-attention layer may accept n inputs and return n outputs, allowing the inputs to interact with each other and identifying which should be paid more attention to (e.g., via a self-attention mechanism of the sequential machine learning model). For example, the sequential machine learning model may be a transformer, and the at least one self-attention layer may employ a self-attention mechanism of the transformer model. The data associated with the plurality of sequences may be encoded by modeling system 102 before being input to the at least one self-attention layer (e.g., using at least one embedding layer). Each self-attention layer of the one or more self-attention layers may be connected to another self-attention layer by a feed forward layer, which processes the output from one self-attention layer (e.g., connected directly before the feed forward layer) and applies weights to the output before passing the weights and outputs as input to the next self-attention layer (e.g., connected directly after the feed forward layer). At least one self-attention layer and at least one feed-forward layer may be referred to, in combination, as a self-attention block.

As shown in FIG. 4, at step 404, process 400 may include determining a plurality of sequential dependencies. For example, modeling system 102 may determine a plurality of sequential dependencies between items in the plurality of sequences using the at least one self-attention layer. In some non-limiting embodiments or aspects, the at least one self-attention layer may employ a self-attention process (e.g., using a multi-head attention technique) that runs through an attention mechanism several times in parallel, which allows for attending to items in a sequence differently (e.g., longer-term dependencies versus shorter-term dependencies). Each sequential dependency of the plurality of sequential dependencies may be weighted by a feed forward layer to indicate the weight that the dependency should be given (e.g., the strength or importance of each inter-item relationship). A greater weight may indicate a more significant sequential dependency, and a lesser weight may indicate a less significant sequential dependency.

In some non-limiting embodiments or aspects, determining the plurality of sequential dependencies, at step 404, may include providing the plurality of sequential dependencies to at least one feed forward layer. For example, modeling system 102 may provide the plurality of sequential dependencies to at least one feed forward layer of the sequential machine learning model. When the at least one self-attention layer is a plurality of self-attention layers, each feed forward layer may connect at least two self-attention layers of the plurality of self-attention layers, processing the output from a self-attention layer connected directly before the feed forward layer and passing the processed output, as input, to a self-attention layer connected directly after the feed forward layer.

In some non-limiting embodiments or aspects, determining the plurality of sequential dependencies, at step 404, may include generating a plurality of weights associated with the plurality of sequential dependencies. For example, modeling system 102 may generate, using the at least one feed forward layer, a plurality of weights associated with the plurality of sequential dependencies based on the plurality of sequential dependencies. When the at least one self-attention layer is a plurality of self-attention layers, each feed forward layer may connect two self-attention layers of the plurality of self-attention layers, applying weights to the output of the self-attention layer connected directly before the feed forward layer, before passing the weights and dependencies as input to the self-attention layer connected directly after the feed forward layer.

In some non-limiting embodiments or aspects, determining the plurality of sequential dependencies, at step 404, may include stabilizing the sequential machine learning model. For example, modeling system 102 may stabilize the sequential machine learning model against perturbations in the data. In some non-limiting embodiments or aspects, stabilizing the sequential machine learning model may include regularizing at least one self-attention block, wherein the at least one self-attention block includes one or more self-attention layers of the at least one self-attention layer and the at least one feed forward layer. In some non-limiting embodiments or aspects, regularizing the at least one self-attention block may include regularizing the at least one self-attention block using a Jacobian regularization technique. A Jacobian regularization technique is described below in connection with Formulas 37 to 46 and the accompanying detailed description.

As shown in FIG. 4, at step 406, process 400 may include denoising the plurality of sequential dependencies. For example, modeling system 102 may denoise the plurality of sequential dependencies to produce denoised sequential dependencies. Modeling system 102 may denoise the plurality of sequential dependencies using a trained binary mask. Process 500 for denoising the plurality of sequential dependencies is further described in connection with FIG. 5. After denoising the plurality of sequential dependencies at step 406, modeling system 102 may proceed to use the trained sequential machine learning model, which now has denoised sequential dependencies (e.g., by generating an output at step 306 and performing an action at step 308, in process 300; see FIG. 3).

Referring now to FIG. 5, is a flowchart of a non-limiting embodiment or aspect of a process 500 for denoising a plurality of sequential dependencies. The steps shown in FIG. 5 are for example purposes only. It will be appreciated that additional, fewer, different, and/or a different order of steps may be used in non-limiting embodiments or aspects. In some non-limiting embodiments or aspects, one or more of the steps of process 500 may be performed (e.g., completely, partially, and/or the like) by modeling system 102. In some non-limiting embodiments or aspects, one or more of the steps of process 500 may be performed (e.g., completely, partially, and/or the like) by another system, another device, another group of systems, or another group of devices, separate from or including modeling system 102.

As shown in FIG. 5, at step 502, process 500 may include applying a trainable binary mask. For example, modeling system 102 may apply at least one trainable binary mask to each self-attention layer of the at least one self-attention layer. At least one binary mask may be used to eliminate irrelevant dependencies in the plurality of sequential dependencies. A technique for using trainable binary masks to denoise sequential dependencies is described below in connection with Formulas 27 to 36 and the accompanying detailed description.

As shown in FIG. 5, at step 504, process 500 may include training the trainable binary mask. For example, modeling system 102 may train the last one trainable binary mask to produce at least one trained binary mask. Because each binary mask of the at least one trainable binary mask is applied to (e.g., associated with) at least one self-attention layer and is trained with (e.g., alongside) the sequential machine learning model, the relevance of sequential dependencies may be learned as they are generated, providing computational efficiencies. For example, a trained binary mask may assign the value of 0 to irrelevant (e.g., noisy) sequential dependencies and a value of 1 to relevant (e.g., not noisy) sequential dependencies.

As shown in FIG. 5, at step 506, process 500 may include excluding sequential dependencies in the plurality of sequential dependencies. For example, modeling system 102 may exclude one or more sequential dependencies in the plurality of sequential dependencies to produce the denoised sequential dependencies based on the at least one trained binary mask. In some non-limiting embodiments or aspects, irrelevant dependencies may be masked (e.g., associated with a value of 0 and ignored) by at least one binary mask, thereby denoising the plurality of sequential dependencies. After excluding one or more sequential dependencies at step 506, modeling system 102 may proceed to use the trained sequential machine learning model, which now has denoised sequential dependencies (e.g., by generating an output at step 306 and performing an action at step 308, in process 300; see FIG. 3).

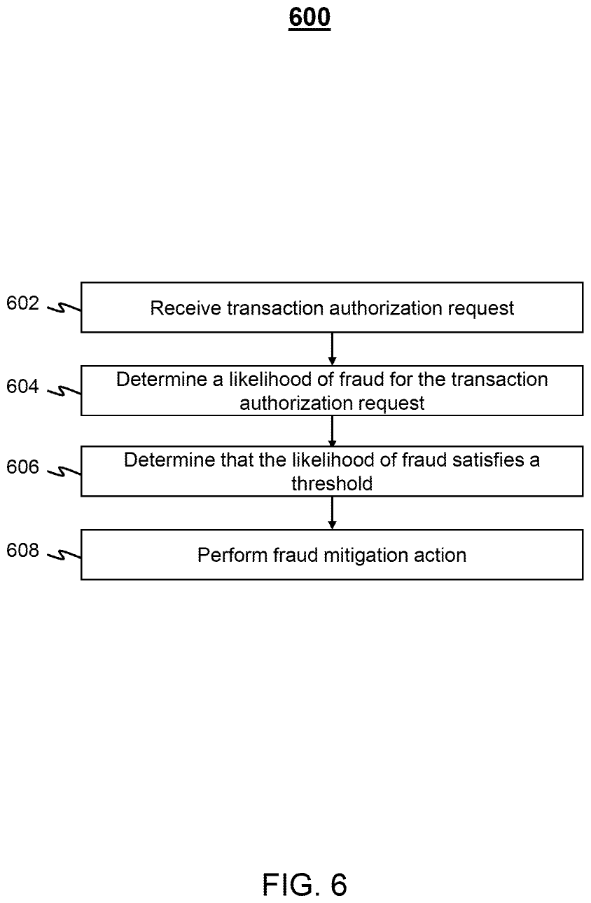

Referring now to FIG. 6, FIG. 6 is a flowchart of a non-limiting embodiment or aspect of a process 600 for using a denoised sequential machine learning model. The steps shown in FIG. 6 are for example purposes only. It will be appreciated that additional, fewer, different, and/or a different order of steps may be used in non-limiting embodiments or aspects. In some non-limiting embodiments or aspects, one or more of the steps of process 600 may be performed (e.g., completely, partially, and/or the like) by modeling system 102 (e.g., being associated with, or included in a same system as, a transaction processing system, fraud detection system, etc.). In some non-limiting embodiments or aspects, one or more of the steps of process 600 may be performed (e.g., completely, partially, and/or the like) by another system, another device, another group of systems, or another group of devices, separate from or including modeling system 102. One or more steps of process 600 may be performed after a sequential machine learning model is trained (e.g., after step 304, see FIG. 3; after step 406, see FIG. 4). In some non-limiting embodiments or aspects, the items of the sequences used to train the sequential machine learning model may be associated with transactions completed by users in an electronic payment processing network.

As shown in FIG. 6, at step 602, process 600 may include receiving a transaction authorization request. For example, modeling system 102 (e.g., being associated with or included in a same system as a transaction processing system) may receive a transaction authorization request associated with a transaction to be completed by a user using a payment device. User may be using the payment device to initiate the transaction with a merchant.

As shown in FIG. 6, at step 604, process 600 may include determining a likelihood of fraud for the transaction authorization request. For example, modeling system 102 (e.g., being associated with or included in a same system as a fraud detection system) may determine a likelihood of fraud for the transaction authorization request based at least partly on a comparison of a transaction type (e.g., category of good/service, merchant category, card-present or card-not-present transaction category, etc.) of the transaction to a transaction type associated with the prediction of the item associated with the sequence of items. By way of further example, if the prediction of the item associated with the sequence of items is an online transaction for a luxury watch, then a transaction type (e.g., luxury apparel, luxury retailer, card-not-present online transaction, etc.) may be compared to a corresponding transaction type of the transaction for which the transaction authorization request was received. To illustrate, if the transaction of the transaction authorization request is for an in-person purchase of gift cards at a gas station (e.g., fungible goods, gasoline retailer, card-present transaction, etc.), then the transaction type of the transaction may be determined to be dissimilar to the transaction type of the prediction, which may contribute to a higher likelihood of fraud. The determined likelihood of fraud may be a categorical determination (e.g., low, medium, high, etc.), a numerical determination (e.g., a value from 0 to 100, where 0 is lowest likelihood of fraud and 100 is highest likelihood of fraud), or any combination thereof. The determined likelihood of fraud may be partly based on other aspects of a fraud detection technique, which may be used in combination with the comparison of the predicted transaction type to the present transaction type, described above.

As shown in FIG. 6, at step 606, process 600 may include determining that the likelihood of fraud satisfies a threshold. For example, modeling system 102 may compare the likelihood of fraud determined in step 604 with a predetermined threshold (e.g., a category and/or value that is manually or automatically set such that, if the threshold is satisfied, fraud mitigation actions are executed). If the threshold is not satisfied (e.g., not met or exceeded), then transactions may continue to be processed for the user as normal. If the threshold is satisfied (e.g., met or exceeded), then one or more fraud mitigation actions may be triggered, such as in step 608.

As shown in FIG. 6, at step 608, process 600 may include performing a fraud mitigation action. For example, modeling system 102, in response to determining that the likelihood of fraud satisfies the threshold, may perform a fraud mitigation action. In some non-limiting embodiments or aspects, a fraud mitigation action may include, but is not limited to, one or more of the following: declining one or more future transactions associated with the user and/or the payment device of the transaction; transmitting a fraud alert to a merchant system associated with the merchant of the transaction, an issuer system that issued the payment device of the transaction, and/or the user (e.g., user's computing device 106); requesting additional authorization or authentication from the user (e.g., by communicating with computing device 106 or an issuer system to request and receive the additional authorization or authentication); and/or the like.

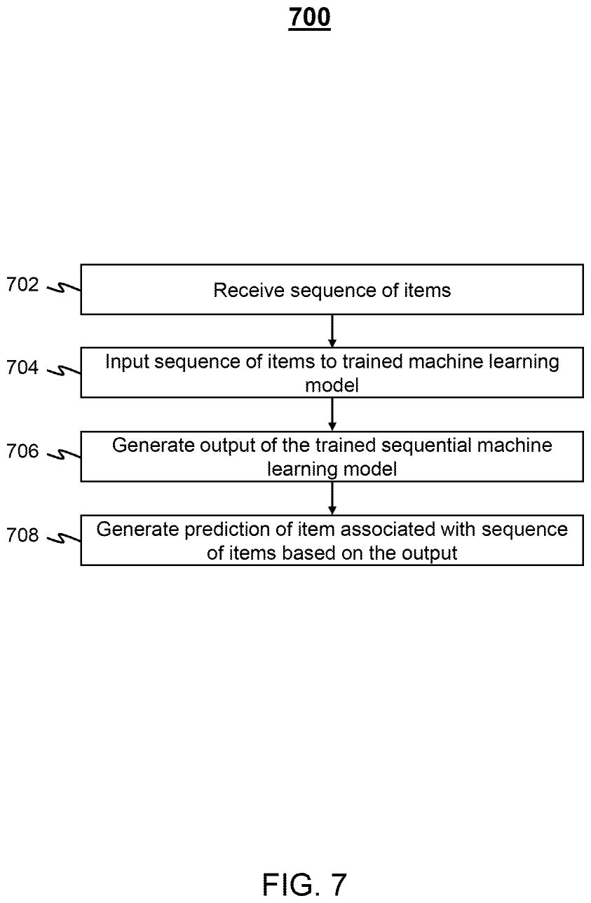

Referring now to FIG. 7, is a flowchart of a non-limiting embodiment or aspect of a process 700 for using a denoised sequential machine learning model. The steps shown in FIG. 7 are for example purposes only. It will be appreciated that additional, fewer, different, and/or a different order of steps may be used in non-limiting embodiments or aspects. In some non-limiting embodiments or aspects, one or more of the steps of process 700 may be performed (e.g., completely, partially, and/or the like) by modeling system 102 (e.g., being associated with, or included in a same system as, a natural language processing system, a transaction processing system, etc.). In some non-limiting embodiments or aspects, one or more of the steps of process 700 may be performed (e.g., completely, partially, and/or the like) by another system, another device, another group of systems, or another group of devices, separate from or including modeling system 102. One or more steps of process 700 may be performed after a sequential machine learning model is trained (e.g., after step 304, see FIG. 3; after step 406, see FIG. 4). In some non-limiting embodiments or aspects, the items of the sequences used to train the sequential machine learning model may be words, such as where the sequential machine learning model is used for natural language processing.

As shown in FIG. 7, at step 702, process 700 may include receiving a sequence of items. For example, modeling system 102 may receive the sequence of items (e.g., from computing device 106, sequence database 104, etc.). In some non-limiting embodiments or aspects, the sequence of items may be a sequence of words received from computing device 106 of a user. By way of further example, the user may have entered a sequence of words (e.g., text input) into computing device 106 (e.g., a web browser search bar), which may be transmitted to modeling system 102. In some non-limiting embodiments or aspects, modeling system 102 may receive text in piecemeal (e.g., portions transmitted at different times) from computing device 106, which may be interpreted by modeling system 102 as a sequence of words.

As shown in FIG. 7, at step 704, process 700 may include inputting the sequence of items to the trained sequential machine learning model. For example, modeling system 102 may input the sequence of items, being a sequence of words, into the trained sequential machine learning model. The words may be input via an embedding layer, and sequential dependencies between words in the input sequence may be identified and compared to known dependencies of words in training sequences for the purposes of generating an output from the trained sequential machine learning model.

As shown in FIG. 7, at step 706, process 700 may include generating an output of the trained sequential machine learning model. For example, modeling system 102 may generate an output of the trained sequential machine learning model based on the input of the sequence of words. The output of the trained sequential machine learning model may be a word occurring directly after the words of the input sequence, or at some point after the words of the input sequence (e.g., a second word after, a third word after, etc.).

As shown in FIG. 7, at step 708, process 700 may include generating a prediction of an item associated with the sequence of items based on the output. For example, modeling system 102 may generate the prediction of a word (as the item) associated with the input sequence of words based on the output of the trained sequential machine learning model. The prediction may be a word that completes a sequence of words that contains the input sequence of words (e.g., a prediction for an input of “fast food restaurants near” may be the word “me”, to suggest the fuller sequence of “fast food restaurants near me”).

In some non-limiting embodiments or aspects, modeling system 102 may transmit the predicted word. For example, modeling system 102 may transmit the word of the prediction to computing device 106 of the user. In some non-limiting embodiments or aspects, the word may be transmitted in a message configured to cause the display of computing device 106 to render the word. By way of further example, when computing device 106 receives the message from modeling system 102, computing device 106 may update a user interface to display the word (e.g., in a text field, in a drop-down box, in a search field of a navigation bar, and/or the like).

While the non-limiting embodiments or aspects of FIGS. 6 and 7 are presented for the purposes of illustrating useful applications of trained and denoised sequential machine learning models according to the present disclosure, it will be appreciated that there are many other useful applications for trained and denoised sequential machine learning models, and process 600 and process 700 should not be taken as limiting on the applications for trained and denoised sequential machine learning models.

Referring now to FIG. 8, FIG. 8 is a diagram of non-limiting embodiment or aspect of sequential machine learning model 800. In some non-limiting embodiments or aspects, sequential machine learning model 800 may be a transformer model and may include a self-attention network, which may include one or more embedding layers 804, one or more self-attention layers 806, one or more binary masks 808, one or more feed forward layers 810, and one or more prediction layers (e.g., including one or more feed forward layers 810 that terminate and produce a final output). In some non-limiting embodiments or aspects, sequential machine learning model 800 may be trained and used by modeling system 102.

In some non-limiting embodiments or aspects, during a training or prediction process using sequential machine learning model 800, modeling system 102 may provide, to one or more embedding layers 804, a sequence of items as input, and generate, using one or more embedding layers 804, representations of the items in the sequence (e.g., an embedding of the input sequence) as output for use in the self-attention network. Modeling system 102 may provide, to one or more self-attention layers 806, the representations of the items in the sequence as input, and apply, using one or more self-attention layers 806, a self-attention mechanism to generate, as output, sequential dependencies between items in the sequence. Modeling system 102 may apply one or more binary masks 808 to one or more self-attention layers 806 and train one or more binary masks 808 with sequential machine learning model 800 so that one or more binary masks 808 learn and exclude sequential dependencies in the plurality of sequential dependencies that are less or not relevant (e.g., to prune noisy items or subsequences). The masking nature of one or more binary masks 808 is illustrated in FIG. 8 in a callout bubble, which demonstrates relevant attentions (e.g., non-noisy dependencies) as solid lines and irrelevant attentions (e.g., noisy dependencies) as dashed lines. One or more binary masks 808 and one or more self-attention layers 806, in combination, may be referred to as the self-attention network of sequential machine learning model 800.

Modeling system 102 may provide, to one or more feed forward layers 810, the plurality of sequential dependencies from one or more self-attention layers 806 as input, and generate, using one or more feed forward layers 810, a plurality of weights associated with the plurality of sequential dependencies as output. In some non-limiting embodiments or aspects, modeling system 102 may produce, using one or more feed forward layers 810 acting as a prediction layer, an output based on the plurality of sequential dependencies and/or the plurality of weights. In some non-limiting embodiments or aspects, modeling system 102 may pass, using one or more feed forward layers 810, a plurality of sequential dependencies received from one self-attention layer to another self-attention layer of one or more self-attention layers 806 (e.g., in configurations of sequential machine learning model 800 having a plurality of self-attention layers). One or more self-attention layers 806 in combination with one or more feed forward layers 810 may be referred to as a self-attention block.

Modeling system 102 may generate, using one or more prediction layers including one or more feed forward layers 810, an output associated with one or more items based on the plurality of sequential dependencies and/or the plurality of weights. For example, the output of one or more prediction layers may include one or more items predicted to follow the input sequence of items. In some non-limiting embodiments or aspects, the one or more items following the input sequence of items may be predicted to occur at an immediately following sequential position (e.g., the first sequential position following the input sequence, and any further immediately following positions). In some non-limiting embodiments or aspects, the one or more items following the input sequence of items may be predicted to occur at sequential positions that are not at an immediately following sequential position (e.g., a second, third, and/or later sequential position following the input sequence, in which one or more intervening items may occur at positions after the input sequence but before the predicted one or more items).

In some non-limiting embodiments or aspects, modeling system 102 may execute a training process for sequential machine learning model 800. In some non-limiting embodiments or aspects, modeling system 102 may receive data associated with a plurality of sequences; and each sequence of the plurality of sequences (e.g., a plurality of input sequences) may include a plurality of items. In some non-limiting embodiments or aspects, modeling system 102 may train sequential machine learning model 800 based on the data associated with the plurality of sequences to produce a trained sequential machine learning model 800. In some non-limiting embodiments or aspects, modeling system 102 may train sequential machine learning model 800 by (i) inputting the data associated with the plurality of sequences (e.g., each as an instance of an input sequence) to a one or more self-attention layers 806 (e.g., via one or more embedding layers 804) of sequential machine learning model 800, (ii) determining a plurality of sequential dependencies between two or more items in a sequence using the one or more self-attention layers 806, and (iii) denoising the plurality of sequential dependencies to produce denoised sequential dependencies. In some non-limiting embodiments or aspects, modeling system 102 may denoise the plurality of sequential dependencies by (i) applying one or more binary masks 808 to each self-attention layer of one or more self-attention layers 806, (ii) training one or more binary masks 808 to produce one or more trained binary masks 808, and (iii) excluding one or more sequential dependencies in the plurality of sequential dependencies to produce the denoised sequential dependencies based on the one or more trained binary masks 808. In some non-limiting embodiments or aspects, modeling system 102 may generate an output (e.g., via one or more prediction layers) of trained sequential machine learning model 800 based on the denoised sequential dependencies and generate a prediction of an item associated with a sequence of items based on the output.

In some non-limiting embodiments or aspects, modeling system 102 may train sequential machine learning model 800 by providing the plurality of sequential dependencies to one or more feed forward layers 810 of sequential machine learning model 800 and generate a plurality of weights associated with the plurality of sequential dependencies. In doing so, modeling system's 102 prediction of the item associated with the sequence of items may be based on the weights associated with the plurality of sequential dependencies. In some non-limiting embodiments or aspects, modeling system 102 may further train sequential machine learning model 800 by stabilizing sequential machine learning model 800 against perturbations in the data, which may include regularizing at least one self-attention block (e.g., one or more self-attention layers 806 and one or more feed forward layers 810) of sequential machine learning model 800, such as by using a Jacobian regularization technique.

In some non-limiting embodiments or aspects, modeling system 102 may execute a prediction process for trained sequential machine learning model 800. In some non-limiting embodiments or aspects, modeling system 102 may receive a new sequence of items and input the received sequence of items to trained sequential machine learning model 800. In some non-limiting embodiments or aspects, modeling system 102 may generate a targeted advertisement based on the prediction and transmit the targeted advertisement to computing device 106 of the user. In some non-limiting embodiments or aspects, modeling system 102 may receive a transaction authorization request, determine a likelihood of fraud for the transaction authorization request based on the prediction, determine that the likelihood of fraud satisfies a threshold, and perform a fraud mitigation action in response to determining that the likelihood of fraud satisfies the threshold. In some non-limiting embodiments or aspects, the sequence of items may include a sequence of words, in which case modeling system 102 may receive the sequence of words from computing device 106 (e.g., of a user), generate the prediction of a word by inputting the sequence of words to trained sequential machine learning model 800, and transmit the word back to computing device 106.

Further described are techniques for training and using sequential machine learning model 800, according to non-limiting embodiments or aspects of the disclosure. As illustrated, sequential machine learning model 800 generates an output (e.g., a sequential prediction, also referred to as a sequential recommendation) from a sequence of items that contains irrelevant subsequences of items (e.g., a noisy sequence) (a subsequence of a sequence of items may include two or more items appearing sequentially adjacent in the sequence). For example, a father may interchangeably purchase {phone, headphone, laptop} for his son, and {bag, pant} for his daughter, resulting in sequence of items: {phone, bag, headphone, pant, laptop}. In the setting of sequential prediction, it is intended to infer the next item (e.g., laptop), based on the user's previous actions (e.g., phone, bag, headphone, pant). A trustworthy model should be able to capture correlated items while ignoring these irrelevant items or subsequences within input sequences. Known self-attentive sequential modeling techniques may be insufficient to address noisy subsequences within sequences, because their full-attention distributions are dense and they may treat all items and subsequences as relevant. This may cause a lack of focus and make such models less interpretable.

To solve the above issue, described methods introduce trainable binary masks 808 (e.g., differentiable masks) to ignore task-irrelevant attentions in self-attention layers 806, which may yield exactly zero probability of relevance for noisy items or subsequences. Binary mask 808, for example, may define what parts of a set of values are relevant (e.g., defining a region of interest), where relevant parts in the set are associated with a binary value of 1 and irrelevant parts in the set are associated with a binary value of 0. Irrelevant parts that are associated with a value of 0 may be ignored-thereby eliminating such irrelevant parts from the greater model. Doing so helps achieve model sparsity. Further to that end, irrelevant attentions with parameterized masks may be learned to be excluded in a data-driven way. Taking FIG. 8 as an example, modeling system 102 may prune (e.g., selectively eliminate irrelevant subsequences within) the sequence {phone, bag, headphone} for pant (e.g., removing phone and headphone), and {phone, bag, headphone, pant} for laptop (e.g., removing bag and pant) in the attention map, thereby basing an output (and, therefore, a prediction) explicitly on a subset of more informative items and subsequences. Another benefit is that non-limiting embodiments or aspects of the present disclosure provide ease of implementation and compatibility in deploying transformers, but with modifications to underlying attention distributions, such that the executed solution is less complicated and more easily interpretable.

The discreteness of binary masks 808 (e.g., values/parts associated with 0 are dropped while values/parts associated with 1 are kept) is another issue addressed by the present disclosure. Non-limiting embodiments or aspects of the present disclosure relax the discrete variables with a continuous approximation through probabilistic reparameterization. Non-limiting embodiments or aspects of the present disclosure use an unbiased and low-variance gradient estimator to effectively estimate the gradients of binary variables, which allow the differentiable masks to be trained jointly with the original transformers in an end-to-end fashion. The following sections provide further detailed explanation for non-limiting embodiments and aspects of the present disclosure. The below-described steps may be carried out, for example, by modeling system 102 of the environment 100 described in connection with FIG. 1.

The following formula may be used to represent a set of user's actions for sequential prediction:

$$𝒮 = \{ {𝒮}^{1} , {𝒮}^{2} , … , {𝒮}^{\vert 𝒰 \vert} \} , \qquad Formula 1$$

where U is a set of users and/is a set of items, with which user may interact (as action S) at a given time step t. Accordingly, the following formula may denote a sequence of items of user u∈U in chronological order:

$${𝒮}^{u} = ( {𝒮}_{1}^{u} , {𝒮}_{2}^{u} , … , {𝒮}_{\vert {𝒮}^{u} \vert}^{u} ) , \qquad Formula 2$$

where the following formula represents the item that user u has interacted with at time step t:

$${S}_{t}^{u} ∈ ℐ , \qquad Formula 3$$

and |S^{u}| is the length of the sequence.

Given an interaction history S^{u}, modeling system 102 seeks to predict the next item (represented below) using sequential machine learning model 800:

$${𝒮}_{\vert {𝒮}^{u} + 1 \vert}^{u} \qquad Formula 4$$

at time step |S^{u}+1|. During the training process, sequential machine learning model's 800 input sequence may be represented by:

$$( {S}_{1}^{u} , {S}_{2}^{u} , … , {S}_{\vert {S}^{u} - 1 \vert}^{u} ) , \qquad Formula 5$$

and sequential machine learning model's 800 expected output may be represented by a shifted version of the input sequence (as illustrated in FIG. 8):

$$( {S}_{2}^{u} , {S}_{3}^{u} , … , {S}_{\vert {S}^{u} \vert}^{u} ) . \qquad Formula 6$$

Embedding layer 804 is shown in FIG. 8. For each input sequence (see Formula 5), modeling system 102 may convert the sequence into a fixed-length sequence (s₁, s₂, . . . , sₙ), where n is the maximum length to be evaluated. The maximum length may be used to preserve the most recent n items by truncating or padding items (e.g., zero padding) when needed.

Modeling system 102 may maintain an item embedding matrix for all items, which may be represented as follows:

$$M ∈ {ℝ}^{\vert ℐ \vert \times d} , \qquad Formula 7$$

where d is the dimension size. Modeling system 102 may further retrieve the input embedding for a sequence (s₁, s₂ . . . , sₙ), which may be represented as follows:

$$E \times {ℝ}^{n \times d} , \qquad Formula 8 A$$

$$where : {E}_{i} = {M}_{{s}_{i}} . \qquad Formula 8 B$$

In order to capture the effects of different positions, modeling system 102 may further inject a learnable positional embedding:

$$P ∈ {ℝ}^{n \times d} \qquad Formula 9$$

into the original input embedding as:

$$\hat{E} = E + P , \qquad Formula 10$$

$$where \hat{E} ∈ {ℝ}^{n \times d} \qquad Formula 11$$

is an order-aware embedding, which can be directly fed to a transformer-based model (e.g., sequential machine learning model 800). In this manner, inputs of sequences of items can be fed into sequential machine learning model 800 for training purposes.

Self-attention layer 806 is shown in FIG. 8. Self-attention layers 806 are highly efficient modules of transformer models that uncover sequential dependencies in a sequence. Modeling system 102 may use scaled dot-product attention as an attention kernel of one or more self-attention layers 806, as follows:

$$Attention ( Q , K , V ) = softmax ( \frac{{QK}^{T}}{\sqrt{d}} ) V , \qquad Formula 12$$

where Q, K, and V represent the queries, keys, and values, respectively and √(d) represents a scale factor to produce a softer attention distribution.

Modeling system 102 may use, as input to one or more self-attention layers 806, the embedding Ê (see Formula 11), convert the embedding to three matrices via linear projections, and feed the three matrices into one or more self-attention layers 806:

$$S = Attention ( \hat{E} {W}^{Q} , \hat{E} {W}^{K} , \hat{E} {W}^{V} ) \qquad Formula 13$$

$$where$$

$$S ∈ {ℝ}^{n \times d} \qquad Formula 14$$

represents the output of self-attention layers 806, and the projection matrices:

$$\{ {W}^{Q} , {W}^{K} , {W}^{V} \} ∈ {ℝ}^{d \times d} \qquad Formula 15$$

improve the flexibility of the attention maps (e.g., asymmetry). Modeling system 102 may use left-to-right unidirectional attentions or bidirectional attentions to predict a next item using sequential machine learning model 800. Moreover, modeling system 102 may apply h attention functions in parallel to enhance expressiveness:

$$\begin{matrix}H = MultiHead ( \hat{E} ) = Concat [ {head}_{1} , … , {head}_{h} ] W , \\ {head}_{i} = Attention ( \hat{E} {W}_{i}^{Q} , \hat{E} {W}_{i}^{K} , \hat{E} {W}_{i}^{V} ) ,\end{matrix} \qquad Formula 16$$

$$where$$

$$\{ {W}_{i}^{Q} , {W}_{i}^{K} , {W}_{i}^{V} \} ∈ {ℝ}^{d \times d / h} \qquad Formula 17$$

$$and$$

$$W ∈ {ℝ}^{d \times d} \qquad Formula 18$$

are learnable parameters, and

$$H ∈ {ℝ}^{n \times d} \qquad Formula 19$$

is the final embedding for the input sequence.

Feed forward layer 810 is shown in FIG. 8. As self-attention is built on linear projections, non-linearity may be endowed by introducing point-wise, two-layer feed forward layers 810:

$${F}_{i} = FFN ( {H}_{i} ) = ReLU ( {H}_{i} {W}^{( 1 )} + {b}^{( 1 )} ) {W}^{( 2 )} + {b}^{( 2 )} , \qquad Formula 20$$

where FFN( ) represents the feed forward network function, ReLU( ) represents the rectified linear unit function, and

$${W}^{\text{(*} )} ∈ {ℝ}^{d \times d} \qquad Formula 21$$

are weights, and

$${b}^{( * )} ∈ {ℝ}^{d} \qquad Formula 22$$

are biases, respectively.

In some non-limiting embodiments or aspects, it may be beneficial to learn hierarchical item dependencies by stacking additional self-attention layers. Doing so may increase the complexity of the model and increase model training time. These issues can be addressed by adopting residual connection, dropout, and layer normalization, to stabilize and accelerate the training. The l-block (l>1) may be defined as:

$$\begin{matrix}{H}^{( l )} = LN ( Dropout ( MultiHead ( {F}^{( l - 1 )} ) + {F}^{( l - 1 )} ) , \\ {F}^{( l )} = LN ( Dropout ( FFN ( {H}^{( l )} ) + {H}^{( l )} ) ,\end{matrix} \qquad Formula 23$$

where the first block is initialized with H⁽¹⁾=H (see Formula 16), F⁽¹⁾=F (see Formula 20), and LN( ) represents the layer normalization function. A self-attention block may include at least one self-attention layer 806 (e.g., self-attention layer 806) and at least one feed forward layer (e.g., feed forward layer 810).

After stacked L self-attention blocks, modeling system 102 may predict the next item (given the first t items) based on F (L). Modeling system 102 may use the inner product to predict the relevance r of item i as follows:

$${r}_{i , t} = {F}_{t}^{( L )} {M}_{i} , \qquad Formula 24$$

$$where$$

$${M}_{i} ∈ {ℝ}^{d} \qquad Formula 25$$

is the embedding of item i. As noted above, sequential machine learning model 800 may receive an input of sequence s=(s₁, s₂, . . . , sₙ), and sequential machine learning model's 800 output may be a shifted version of the same sequence o=(o₁, o₂, . . . , oₙ). Accordingly, sequential machine learning model 800 may use binary cross-entropy loss L_{BCE} as the objective:

$${ℒ}_{BCE} = - {\sum }_{{𝒮}^{u} ∈ 𝒮} {\sum }_{t = 1}^{n} [ log ( σ ( {r}_{{o}_{t}} , t ) ) + log ( 1 - σ ( {r}_{{o}_{t}^{′} , t} ) ) ] + α {‖ Θ ‖}_{F}^{2} \qquad Formula 26$$

where Θ represents model parameters, a represents the regularizer to prevent over-fitting, o′ₜ∉S^{u} is a negative sample corresponding to oₜ, and σ( ) is the sigmoidal function.

The self-attention layer of transformers capture long-range dependencies. As shown in Formula 12, the softmax operator may assign a non-zero weight to every item. However, full attention distributions may not always be advantageous since they may cause irrelevant dependencies, unnecessary computation, and unexpected explanation. The disclosed methods use differentiable masks to address this concern.

In sequential predictions, not every item in a sequence may be relevant (e.g., aligned well with user preferences for a recommendation-based sequential machine learning model), in the same sense that not all attentions are strictly needed in self-attention layers. Therefore, modeling system 102 may attach each self-attention layer 806 with a trainable binary mask 808 to prune noisy or task-irrelevant attentions. Formally, for the l-th self-attention layer in Formula 12, modeling system 102 may introduce a binary matrix Z^{(l)}∈{0,1}^{nxn}, where Z^{(l)}_{u,v} denotes whether the connection between query u and key v is present. As such, the l-th self-attention layer becomes:

$$\begin{matrix}{A}^{( l )} = softmax ( \frac{{Q}^{( l )} {K}^{( l ) T}}{\sqrt{d}} ) , \\ {S}^{( l )} = {A}^{( l )} ⊙ {Z}^{( l )} , \\ Attention ( {Q}^{( l )} , {K}^{( l )} , {V}^{( l )} ) = {S}^{( l )} {V}^{( l )} ,\end{matrix} \qquad Formula 27$$

where A^{(l)} denotes the original full attentions, S^{(l)} denotes the sparse attentions, and ⊙ denotes the element-wise product. In view of the above, the mask Z^{(l)} (e.g., 1 is kept and 0 is dropped) requires minimal changes to the original self-attention layer and may yield exactly zero probabilities for irrelevant dependencies, resulting in better interpretability.

Modeling system 102 may further encourage sparsity of S (I) by explicitly penalizing the number of non-zero entries of Z^{(l)}, for 1≤l≤L, by minimizing:

$${ℛ}_{S} = {\sum }_{l = 1}^{L} {‖ {Z}^{( l )} ‖}_{0} = {\sum }_{l = 1}^{L} {\sum }_{u = 1}^{n} {\sum }_{υ = 1}^{n} 𝕀 [ {Z}_{u , υ}^{( l )} \neq 0 ] , \qquad Formula 28$$

where [symbol] [c] is an indicator function that is equal to 1 if the condition c holds, 0 otherwise, and ∥·∥₀ denotes the L₀ norm that can drive irrelevant attentions to be exact zeros.

There are two challenges for optimization Z (I): non-differentiability and large variance. L₀ is discontinuous and has zero derivatives almost everywhere. Additionally, there are 2\hat{ }n\hat{ }2 possible states for the binary mask Z^{(l)} with large variance. Solutions to this stochastic binary optimization problem are further described below.

Since Z^{(l)} is jointly optimized with the original transformer-based models, modeling system 102 may combine Formula 26 with Formula 28 into one unified objective:

$$ℒ ( Z , Θ ) = {ℒ}_{BCE} ( \{ {A}^{( l )} ⊙ {Z}^{( l )} \} , Θ ) + β {{\sum }_{l = 1}}^{L} {{\sum }_{u = 1}}^{n} {\sum }_{υ = 1}^{n} 𝕀 [ {Z}_{u , υ}^{( l )} \neq 0 ] , \qquad Formula 29$$

where β controls the sparsity of masks. Each Z^{(l)}_{u,v} may be drawn from a Bernoulli distribution parameterized by Π^{(l)}_{u,v}, such that Z^{(l)}_{u,v}˜Bern (Π^{(l)}_{u,v}) . As the parameter Π^{(l)}_{u,v} is jointly trained with downstream tasks, a small value of Π^{(l)}_{u,v} suggests that the attention A^{(l)}_{u,v} is more likely to be irrelevant and, therefore, could be removed without side effects. By doing this, Formula 29 becomes:

$$ℒ ( Z , Θ ) = {𝔼}_{Z ∼ {\prod }_{l = 1}^{L} Bern ( {Z}^{( l )} ; {\prod }^{( l )} )} [ {ℒ}_{BCE} ( Z , Θ ) ] + β {{\sum }_{l = 1}}^{L} {{\sum }_{u = 1}}^{n} {\sum }_{υ = 1}^{n} {\prod }_{u , υ}^{( l )} , \qquad Formula 30$$

where [symbol] (·) is the expectation. The regularization term is now continuous, but the first term L_{BCE}(Z, Θ) still involves the discrete variables Z^{(l)}. Modeling system 102 may address this issue by using gradient estimators (e.g., REINFORCE, Gumbel-Softmax, Straight Through Estimator, etc.). Alternatively, modeling system 102 may directly optimize with respect to discrete variables by using the augment-REINFORCE-merge (ARM) technique, which is unbiased and has low variance.

In particular, modeling system 102 may execute a reparameterization process, which reparameterizes Π^{(l)}_{u,v}∈[0,1] to a deterministic function g( ) with parameters ϕ^{(l)}_{u,v}, such that:

$${\prod }_{u , υ}^{( l )} = ℊ ( {Φ}_{u , υ}^{( l )} ) , \qquad Formula 31$$

and since the deterministic function g( ) may be bounded within [0,1], modeling system 102 may use the standard sigmoid function as the deterministic function:

$$g ( x ) = 1 / ( 1 + {e}^{- x} ) \qquad Formula 32$$

Using the ARM technique, modeling system 102 may compute the gradients for Formula 30 as:

$${∇}_{Φ}^{ARM} ℒ ( Φ , Θ ) = {𝔼}_{U ∼ {\prod }_{l = 1}^{L} Uni ( {U}^{( l )} ; 0 , 1 )} [ ( {ℒ}_{BCE} ( 𝕀 [ U > g ( - Φ ) ] , Θ ) - {ℒ}_{BCE} ( 𝕀 [ U < g ( Φ ) ] , Θ ) ) \cdot ( U - \frac{1}{2} ) ] + β {∇}_{Φ} g ( Φ ) , \qquad Formula 33$$

where Uni(0,1) denotes the Uniform distribution within [0,1], and

$${ℒ}_{BCE} ( 𝕀 [ U > g ( - Φ ) ] , Θ ) \qquad Formula 34$$

is the cross-entropy loss obtained by setting the binary masks Z^{(l)} to 1 if U^{(l)}>g(−ϕ^{(l)}) in the forward pass, and 0 otherwise. Modeling system 102 may apply the same strategy to.

$${ℒ}_{BCE} ( 𝕀 [ U < g ( Φ ) ] , Θ ) . \qquad Formula 35$$

ARM is an unbiased estimator due to the linearity of expectations.

From Formula 33, modeling system 102 evaluates L_{BCE}( ) twice to compute gradients. To reduce the complexity, modeling system 102 may employ a variant of ARM, such as augment-reinforce (AR):

$${∇}_{Φ}^{AR} ℒ ( Φ , Θ ) = {𝔼}_{U ∼ {\prod }_{l = 1}^{L} Uni ( {U}^{( l )} ; 0 , 1 )} [ {ℒ}_{BCE} ( 𝕀 [ U < g ( - Φ ) ] , Θ ) \cdot ( 1 - 2 U ) ] + β {∇}_{Φ} g ( Φ ) , \qquad Formula 36$$

which requires only one forward pass. The gradient estimator of Formula 36 is still unbiased but may have higher variance compared to the gradient estimator of Formula 33. In this manner, modeling system 102 may trade off the variance of the estimator with the complexity in the experiments.

In the training stage, modeling system 102 may alternatively update the gradient estimator of Formula 33 and/or Formula 36, or the original optimization for transformers. In the inference stage, modeling system 102 may use the expectation of Z^{(l)}_{u,v}˜Bern (Π^{(l)}_{u,v}) as the mask in Formula 27. Modeling system 102 may clip the values g(ϕ^{(l)}_{u,v})≤0.5 to zeroes, such that a sparse attention matrix is guaranteed and the corresponding noisy attentions are eventually eliminated.

The standard dot-product self-attention is not Lipschitz continuous and is vulnerable to the quality of input sequences. Let f^{(l)} be the l-th self-attention block that contains both a self-attention layer and a point-wise feed forward layer, and x be the input. Modeling system 102 may measure the robustness of the self-attention block using residual error:

$${f}^{( l )} ( x + ϵ ) - {f}^{( l )} ( x ) , \qquad Formula 37$$

where ϵ is a small perturbation vector and the norm of e is less than or equal to a small scalar δ, i.e.:

$${‖ ϵ ‖}_{2} \leq δ . \qquad Formula 38$$

According to Taylor expansion, the above may be represented by:

$${f}_{i}^{( l )} ( x + ϵ ) - {f}_{i}^{( i )} ( x ) \approx {[ \frac{\partial {f}_{i}^{( l )} ( x )}{\partial x} ]}^{T} ϵ . \qquad Formula 39$$

Let J^{(l)}(x) represent the Jacobian matrix at x where:

$${J}_{ij}^{( l )} = \frac{\partial {f}_{i}^{( l )} ( x )}{\partial {x}_{j}} . \qquad Formula 40$$

Then, modeling system 102 may set:

$${J}_{i}^{( l )} ( x ) = \frac{\partial {f}_{i}^{( l )} ( x )}{\partial x} \qquad Formula 41$$

to denote the i-th row of J^{(l)}(x). According to Holder's inequality, the above may be represented by:

$${‖ {f}_{i}^{( l )} ( x + ϵ ) - {f}_{i}^{( i )} ( x ) ‖}_{2} \approx {‖ {{J}_{i}^{( l )} ( x )}^{T} ϵ ‖}_{2} \leq {‖ {{J}_{i}^{( l )} ( x )}^{T} ‖}_{2} {‖ ϵ ‖}_{2} . \qquad Formula 42$$

The above inequality indicates that regularizing the L₂ norm on the Jacobians enforces a Lipschitz constraint at least locally, and the residual error is strictly bounded. Thus, modeling system 102 may regularize Jacobians with Frobenius norm for each self-attention block, as:

$$L {ℛ}_{J} = \sum {‖ {J}^{( l )} ‖}_{F}^{2} l = 1 \qquad Formula 43$$

With reference to the above, ∥J^{(l)}∥²_{F} may be approximated via a Monte-Carlo estimator. Modeling system 102 may further use the Hutchinson estimator. For each Jacobian:

$${J}^{( l )} ϵ {ℝ}^{n \times n} , \qquad Formula 44$$

modeling system 102 may determine:

$${‖ {J}^{( l )} ‖}_{F}^{2} = Tr ( {J}^{( l )} {J}^{{( l )}^{T}} ) = {𝔼}_{η ∈ 𝒩 ( 0 , {I}_{n} )} [ {‖ {η}^{T} {J}^{( l )} ‖}_{F}^{2} ] , \qquad Formula 45$$

$$where$$

$$η ∈ 𝒩 ( 0 , {I}_{n} ) \qquad Formula 46$$

is the normal distribution. Modeling system 102 may further make use of random projections to compute the norm of Jacobians, which significantly reduces the running time during execution.

Putting together the loss formulations of Formula 26, Formula 28, and Formula 43, modeling system 102 may determine the overall objective function of the disclosed methods as:

$${ℒ}_{Rec - Denoiser} = {ℒ}_{BCE} + β \cdot {ℛ}_{S} + γ \cdot {ℛ}_{J} , \qquad Formula 47$$

where β and γ are regularizers to control the sparsity and robustness of self-attention networks, respectively.

Although the disclosure has been described in detail for the purpose of illustration based on what is currently considered to be the most practical and preferred embodiments or aspects, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect, and one or more steps may be taken in a different order than presented in the present disclosure. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
receiving, with at least one processor, data associated with a plurality of sequences, wherein each sequence of the plurality of sequences comprises a plurality of items;
training, with at least one processor, a sequential machine learning model based on the data associated with the plurality of sequences to produce a trained sequential machine learning model, wherein training the sequential machine learning model comprises:
inputting the data associated with the plurality of sequences to at least one self-attention layer of the sequential machine learning model;
determining a plurality of sequential dependencies between items in the plurality of sequences using the at least one self-attention layer; and
denoising the plurality of sequential dependencies to produce denoised sequential dependencies, wherein denoising the plurality of sequential dependencies comprises:
applying at least one trainable binary mask to each self-attention layer of the at least one self-attention layer;
training the at least one trainable binary mask to produce at least one trained binary mask; and
excluding one or more sequential dependencies in the plurality of sequential dependencies to produce the denoised sequential dependencies based on the at least one trained binary mask;
generating, with at least one processor, an output of the trained sequential machine learning model based on the denoised sequential dependencies; and
generating, with at least one processor, a prediction of an item associated with a sequence of items based on the output of the trained sequential machine learning model.

2. The computer-implemented method of claim 1, wherein training the sequential machine learning model comprises:
providing the plurality of sequential dependencies to at least one feed forward layer of the sequential machine learning model; and
generating, using the at least one feed forward layer, a plurality of weights associated with the plurality of sequential dependencies based on the plurality of sequential dependencies; and
wherein generating the prediction of the item associated with the sequence of items comprises:
generating the prediction of the item associated with the sequence of items based on the weights associated with the plurality of sequential dependencies.

3. The computer-implemented method of claim 1, further comprising:
receiving, with at least one processor, the sequence of items; and
inputting, with at least one processor, the sequence of items to the trained sequential machine learning model;
wherein generating the prediction of the item associated with the sequence of items based on the output of the trained sequential machine learning model comprises:
generating the prediction of the item associated with the sequence of items using at least one prediction layer of the trained sequential machine learning model.

4. The computer-implemented method of claim 3, the method further comprising:
generating, with at least one processor, a targeted advertisement based on the prediction of the item associated with the sequence of items; and
transmitting, with at least one processor, the targeted advertisement to a computing device of a user.

5. The computer-implemented method of claim 3, further comprising:
receiving, with at least one processor, a transaction authorization request associated with a transaction;
determining, with at least one processor, a likelihood of fraud for the transaction authorization request based at least partly on a comparison of a transaction type of the transaction to a transaction type associated with the prediction of the item associated with the sequence of items;
determining, with at least one processor, that the likelihood of fraud satisfies a threshold; and
performing, with at least one processor, a fraud mitigation action in response to determining that the likelihood of fraud satisfies the threshold.

6. The computer-implemented method of claim 3, wherein:
the sequence of items comprises a sequence of words;
wherein receiving the sequence of items comprises:
receiving the sequence of words from a computing device of a user; and
wherein generating the prediction of the item associated with the sequence of items comprises:
generating a prediction of a word associated with the sequence of words; and
the method further comprising:
transmitting, with at least one processor, the word to the computing device of the user.

7. The computer-implemented method of claim 2, wherein at least one self-attention block comprises one or more self-attention layers of the at least one self-attention layer and the at least one feed forward layer, and wherein training the sequential machine learning model comprises:
stabilizing the sequential machine learning model against perturbations in the data, wherein stabilizing the sequential machine learning model comprises:
regularizing the at least one self-attention block.

8. The computer-implemented method of claim 7, wherein regularizing the at least one self-attention block comprises:
regularizing the at least one self-attention block using a Jacobian regularization technique.

9. A system comprising at least one processor programmed or configured to:
receive data associated with a plurality of sequences, wherein each sequence of the plurality of sequences comprises a plurality of items;
train a sequential machine learning model based on the data associated with the plurality of sequences to produce a trained sequential machine learning model, wherein, when training the sequential machine learning model, the at least one processor is programmed or configured to:
input the data associated with the plurality of sequences to at least one self-attention layer of the sequential machine learning model;
determine a plurality of sequential dependencies between items in the plurality of sequences using the at least one self-attention layer; and
denoise the plurality of sequential dependencies to produce denoised sequential dependencies, wherein, when denoising the plurality of sequential dependencies, the at least one processor is programmed or configured to:
apply at least one trainable binary mask to each self-attention layer of the at least one self-attention layer;
train the at least one trainable binary mask to produce at least one trained binary mask; and
exclude one or more sequential dependencies in the plurality of sequential dependencies to produce the denoised sequential dependencies based on the at least one trained binary mask;
generate an output of the trained sequential machine learning model based on the denoised sequential dependencies; and
generate a prediction of an item associated with a sequence of items based on the output of the trained sequential machine learning model.

10. The system of claim 9, wherein, when training the sequential machine learning model, the at least one processor is programmed or configured to:
provide the plurality of sequential dependencies to at least one feed forward layer of the sequential machine learning model; and
generate, using the at least one feed forward layer, a plurality of weights associated with the plurality of sequential dependencies based on the plurality of sequential dependencies; and
wherein, when generating the prediction of the item associated with the sequence of items, the at least one processor is programmed or configured to:
generate the prediction of the item associated with the sequence of items based on the weights associated with the plurality of sequential dependencies.

11. The system of claim 9, wherein the at least one processor is further programmed or configured to:
receive the sequence of items; and
input the sequence of items to the trained sequential machine learning model;
wherein, when generating the prediction of the item associated with the sequence of items, the at least one processor is programmed or configured to:
generate the prediction of the item associated with the sequence of items using at least one prediction layer of the trained sequential machine learning model.

12. The system of claim 11, wherein the at least one processor is further programmed or configured to:
generate a targeted advertisement based on the prediction of the item associated with the sequence of items; and
transmit the targeted advertisement to a computing device of a user.

13. The system of claim 11, wherein the at least one processor is further programmed or configured to:
receive a transaction authorization request associated with a transaction;
determine a likelihood of fraud for the transaction authorization request based at least partly on a comparison of a transaction type of the transaction to a transaction type associated with the prediction of the item associated with the sequence of items;
determine that the likelihood of fraud satisfies a threshold; and
perform a fraud mitigation action in response to determining that the likelihood of fraud satisfies the threshold.

14. The system of claim 11, wherein:
the sequence of items comprises a sequence of words;
wherein, when receiving the sequence of items, the at least one processor is programmed or configured to:
receive the sequence of words from a computing device of a user;
wherein, when generating the prediction of the item associated with the sequence of items, the at least one processor is programmed or configured to:
generate a prediction of a word associated with the sequence of words; and
wherein the at least one processor is further programmed or configured to:
transmit the word to the computing device of the user.

15. A computer program product comprising at least one non-transitory computer-readable medium comprising one or more instructions that, when executed by at least one processor, cause the at least one processor to:
receive data associated with a plurality of sequences, wherein each sequence of the plurality of sequences comprises a plurality of items;
train a sequential machine learning model based on the data associated with the plurality of sequences to produce a trained sequential machine learning model, wherein, the one or more instructions that cause the at least one processor to train the sequential machine learning model, cause the at least one processor to:
input the data associated with the plurality of sequences to at least one self-attention layer of the sequential machine learning model;
determine a plurality of sequential dependencies between items in the plurality of sequences using the at least one self-attention layer; and
denoise the plurality of sequential dependencies to produce denoised sequential dependencies, wherein, the one or more instructions that cause the at least one processor to denoise the plurality of sequential dependencies, cause the at least one processor to:
apply at least one trainable binary mask to each self-attention layer of the at least one self-attention layer;
train the at least one trainable binary mask to produce at least one trained binary mask; and
exclude one or more sequential dependencies in the plurality of sequential dependencies to produce the denoised sequential dependencies based on the at least one trained binary mask;
generate an output of the trained sequential machine learning model based on the denoised sequential dependencies; and
generate a prediction of an item associated with a sequence of items based on the output of the trained sequential machine learning model.

16. The computer program product of claim 15, wherein, the one or more instructions that cause the at least one processor to train the sequential machine learning model, cause the at least one processor to:
provide the plurality of sequential dependencies to at least one feed forward layer of the sequential machine learning model; and
generate, using the at least one feed forward layer, a plurality of weights associated with the plurality of sequential dependencies based on the plurality of sequential dependencies; and
wherein, the one or more instructions that cause the at least one processor to generate the prediction of the item associated with the sequence of items, cause the at least one processor to:
generate the prediction of the item associated with the sequence of items based on the weights associated with the plurality of sequential dependencies.

17. The computer program product of claim 15, wherein the one or more instructions further cause the at least one processor to:
receive the sequence of items; and
input the sequence of items to the trained sequential machine learning model;
wherein, the one or more instructions that cause the at least one processor to generate the prediction of the item associated with the sequence of items, cause the at least one processer to:
generate the prediction of the item associated with the sequence of items using at least one prediction layer of the trained sequential machine learning model.

18. The computer program product of claim 17, wherein the one or more instructions further cause the at least one processor to:
generate a targeted advertisement based on the prediction of the item associated with the sequence of items; and
transmit the targeted advertisement to a computing device of a user.

19. The computer program product of claim 17, wherein the one or more instructions further cause the at least one processor to:
receive a transaction authorization request associated with a transaction;
determine a likelihood of fraud for the transaction authorization request based at least partly on a comparison of a transaction type of the transaction to a transaction type associated with the prediction of the item associated with the sequence of items;
determine that the likelihood of fraud satisfies a threshold; and
perform a fraud mitigation action in response to determining that the likelihood of fraud satisfies the threshold.

20. The computer program product of claim 17, wherein:
the sequence of items comprises a sequence of words;
wherein, the one or more instructions that cause the at least one processor to receive the sequence of items, cause the at least one processor to:
receive the sequence of words from a computing device of a user;
wherein, the one or more instructions that cause the at least one processor to generate the prediction of the item associated with the sequence of items, cause the at least one processor to:
generate a prediction of a word associated with the sequence of words; and
wherein the one or more instructions further cause the at least one processor to:
transmit the word to the computing device of the user.
